(19) United States
(12) Patent Application Publication
(10) Pub. No.: US 2024/0356771 A1
(43) Pub. Date: Oct. 24, 2024

(54) SCHEDULING COMPUTING DEVICE AND METHOD FOR SCHEDULING

(71) Applicant: MOTOROLA SOLUTION, INC., CHICAGO, IL (US)

(72) Inventors: LUKE YOUNG, TEMECULA, CA (US); ALEXANDER SAPUTA, HOOVER, AL (US); JUAN FELIPE GONZALEZ-GOMEZ, STERRETT, AL (US)

(21) Appl. No.: 18/305,504

(22) Filed: Apr. 24, 2023

(51) Int. Cl. H04L 12/18; H04L 65/1069; H04L 65/1089; H04N 7/18

(52) U.S. Cl. CPC H04L 12/1818; G06Q 10/06315; H04L 12/1822; H04L 65/1069; H04N 7/181; G06Q 50/265

(57) ABSTRACT

A method for scheduling is described. At a scheduling computing device, the method comprises: receiving interview scheduling information that comprises one or more existing electronically-stored case records and at least one interview window time parameter associated with an interview window for a public safety related interview of an interviewee by an interviewer; accessing and processing information contained in the electronically-stored case records, responsive to the at least one interview window time parameter, and identifying one or more locations of interest likely to be relevant to the interview. The method further comprises determining that one or more mobile imaging devices is available prior to the start of the interview window; and causing the one or more available mobile imaging devices to be deployed to the one or more locations of interest prior to the start of the interview window.

### BACKGROUND OF THE INVENTION

Tablets, laptops, phones (e.g., cellular or satellite), mobile (vehicular) or portable (personal) two-way radios, and other communication devices are now in common use by users, such as first responders (including firemen, law enforcement officers, and paramedics, among others), and provide such users and others with instant access to increasingly valuable additional information and resources such as vehicle histories, arrest records, outstanding warrants, health information, real-time traffic or other situational status information, and any other information that may aid the user in making a more informed determination of an action to take or how to resolve a situation, among other possibilities.

Many such communication devices further comprise, or provide access to, electronic digital assistants (or sometimes referenced as “virtual partners”) that may provide the user thereof with valuable information in an automated (e.g., without further user input) or semi-automated (e.g., with some further user input) fashion. The valuable information provided to the user may be based on explicit requests for such information posed by the user via an input (e.g., such as a parsed natural language input or an electronic touch interface manipulation associated with an explicit request) in which the electronic digital assistant may reactively provide such requested valuable information, or may be based on some other set of one or more context or triggers in which the electronic digital assistant may proactively provide such valuable information to the user absent any explicit request from the user.

As some existing examples, electronic digital assistants such as Siri provided by Apple, Inc.® and Google Now provided by Google, Inc.®, are software applications running on underlying electronic hardware that are capable of understanding natural language and may complete electronic tasks in response to user voice inputs, among other additional or alternative types of inputs. These electronic digital assistants may perform such tasks as taking and storing voice dictation for future reference and retrieval, reading a received text message or an e-mail message aloud, generating a text message or e-mail message reply, looking up requested phone numbers and initiating a phone call to a requested contact, generating calendar appointments and providing appointment reminders, warning users of nearby dangers such as traffic accidents or environmental hazards, and providing many other types of information in a reactive or proactive manner.

The inventors have recognized and appreciated a further use for an electronic digital assistant, in a context of public safety work. The inventors have recognized and appreciated that the time between identifying a person of interest relating to a public safety incident or anticipating a public safety incident and scheduling an interview with that person is often underutilized. Furthermore, the inventors have recognized and appreciated that it is important to not lose real-time information, relating to the public safety incident or the anticipated public safety incident, such as whether a weapon may have been thrown/discarded during the incident. The inventors have recognized that real-time feedback to the law enforcement officer(s) at the scene is also important, rather than allocating resources to investigate the incident a reasonable time after the public safety incident.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a system diagram illustrating a system for operating an electronic scheduling digital assistant, in accordance with some embodiments.

FIG. 2 illustrates a device diagram showing a device structure of an electronic computing device for operating an electronic scheduling digital assistant, in accordance with some embodiments.

FIG. 3 illustrates an example of a map provided to an electronic scheduling digital assistant, in accordance with some example embodiments.

FIG. 4 illustrates a data flow diagram between components of the system for operating an electronic scheduling digital assistant of FIG. 1 and/or FIG. 2, in accordance with some embodiments.

FIG. 5 illustrates a flowchart setting forth process steps for operating the electronic scheduling digital assistant of FIG. 1 and/or FIG. 2 and/or FIG. 4, in accordance with some embodiments.

FIG. 6 illustrates a more detailed flowchart setting forth a number of further example process steps for operating the electronic scheduling digital assistant of FIG. 1 and/or FIG. 2 and/or FIG. 4, in accordance with some embodiments.

FIG. 7 illustrates a block diagram of a set of operational circuits of a video capture and playback system, adapted according to one example embodiment.

FIG. 8 illustrates an example of a neural network that may be employed as an artificial intelligence-based learning processor architecture for improved public safety related interviews, according to some example embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments herein described.

The apparatus and method components have been represented where appropriate by conventional symbols in the drawings, showing only those specific details that are pertinent to understanding the embodiments herein described so as not to obscure the disclosure with details that will be readily apparent to those of ordinary skill in the art having the benefit of the description herein.

### DETAILED DESCRIPTION

In many cases, an electronic scheduling digital assistant may perform a task in a context of public safety work. However, the inventors have recognized and appreciated that a problem exists in an interview process following an incident, e.g. an interview of a suspected criminal having committed a crime, that the time between identifying a person of interest relating to a public safety incident or anticipating a public safety incident and scheduling an interview with that person is often underutilized. For example, the inventors have recognized and appreciated that it is important to not lose real-time information, relating to the public safety incident or the anticipated public safety incident, such as whether a weapon may have been thrown. Furthermore, the opportunity to obtain real-time instructions to public safety offices and obtain real-time feedback from the public safety offices at the scene is also important.

Thus, there exists a need for an improved technical method, device, and system for an electronic scheduling digital assistant to provide real-time (or at least improved) information at public safety related interviews. As such, the inventors have recognized and appreciated that an electronic digital assistant can be re-configured, in a context of public safety work, to schedule resources by assisting in substantially a real-time manner, relating to a public safety incident or anticipated public safety incident, rather than the present approach of allocating resources a time period that is typically too long after the public safety incident.

In one embodiment, a method for scheduling is described. The method comprises at a scheduling computing device: receiving interview scheduling information, wherein the interview scheduling information comprises at least one interview window time parameter associated with an interview window for interviewing an interviewee by an interviewer, the at least one interview window time parameter comprising at least one of the following: an interview start time, a scheduled end time of an interview, a date of an interview, a minimum duration of an interview. The method further comprises accessing, responsive to the at least one interview window time parameter, one or more electronically-stored existing case record associated with a public safety related interview; processing information contained in the one or more electronically-stored existing case record, and identifying one or more locations of interest relevant to the interview; determining that one or more mobile imaging device(s) is available prior to the start of the interview window; and causing the one or more available mobile imaging device(s) to be deployed to the one or more locations of interest prior to a start of the interview window.

In some examples, the interview scheduling information may be automatically provided to the scheduling computing device when an interview room, say at a Police station, is booked, or may be manually provided to the scheduling computing device by an interviewer. In some examples, the interview scheduling information includes one or more electronically-stored existing case record. In this context, an electronically-stored case record encompasses any details of an identified incident, such as a vehicular accident, a burglary, an attack, etc. In some examples, the electronically-stored existing case record may include any recorded or input details prior to the incident, such as a report of suspicious activity or a sighting of a known criminal. In some examples, the interview scheduling information includes at least one interview window time parameter associated with an interview window. An interview window may encompass a planned time for interviewing an interviewee by an interviewer, for example in an interview room at a Police station. In some examples, the at least one interview window time parameter may include at least one of the following: an interview start time, a scheduled end time of an interview, a date of an interview, a minimum duration of an interview, etc. In some examples, the at least one interview window time parameter may include a minimum time period for the interview to take, to allow one suspect or witness interview to be concurrently held, or other suspects to be identified and brought to the Police station, say.

In some examples, the scheduling computing device accesses, responsive to the at least one interview window time parameter, one or more electronically-stored existing case record associated with the interview, for example a report of a public safety officer or a witness. Thereafter, in some examples, the scheduling computing device processes information contained in the one or more electronically-stored existing case record and identifies therefrom one or more locations of interest relevant to the interview, for example, locations where a criminal may decide to throw a weapon following a crime. In some examples, the scheduling computing device determines that one or more mobile imaging device(s) is available prior to the start of the interview window, for example to enable the scheduling computing device to receive real-time location information from one or more mobile imaging device(s). Such one or more mobile imaging device(s) may include public safety officers (for example having a body wear camera (BWC)) in the vicinity of an incident, a public safety vehicle (for example having a public safety vehicular camera) that is located in the vicinity of the incident; one or more air-borne resource(s) that is/are available to public safety officers and situations, such as helicopters, drones, etc. In some examples, the scheduling computing device then causes the one or more available mobile imaging device(s) to be deployed to the one or more locations of interest prior to a start of the interview window. In this manner, the scheduling computing device is able to obtain substantially real-time data (e.g., live surveillance data) related to the incident, in response to topics that are discussed in the interview. In this manner, the scheduling computing device is able to direct the one or more available mobile imaging device(s) to be deployed to the one or more locations of interest prior to the interview window, in order to obtain substantially real-time visual data to assist the interviewer in the interview. For example, a drone may be scheduled to fly to a particular location (say over an incident) prior to an interview to validate whether (or not) a witness or a suspect is making an accurate statement based on that location. In particular, an interviewer is also able to walk through an incident scene with a witness or suspect, as a drone (or other mobile imaging device) is directed around the location. In some examples, the scheduling computing device may obtain resource information that may include audio and/or video information, or further location information, e.g., to determine a line of sight confirmation from a witness to an incident, etc. In some examples, it is envisaged that street camera images of cars parked at a time of the incident in question (but likely gone by the time the interview happens) may also be used. In such a scenario, it is envisaged in some examples that a computer vision system may recognize the make/model/color of the cars and then an automatic recognition system may be used to superimpose these vehicles into a live scene (provided by a drone or law enforcement officer, for example) using known parameters about those vehicles. In such a scenario, it is also envisaged in some examples that it may also be possible to blur out vehicles that were not present at the time of the incident being considered in the interview.

In a further embodiment, a scheduling computing device comprises a receiver configured to receive interview scheduling information, wherein the interview scheduling information comprises at least one interview window time parameter associated with an interview window for interviewing an interviewee by an interviewer. The at least one interview window time parameter comprises at least one of: an interview start time, a scheduled end time of an interview, a date of an interview, a minimum duration of an interview. One or more electronic processors are operably coupled to the receiver and configured to: access, responsive to the at least one interview window time parameter, one or more electronically-stored existing case record associated with the interview; process information contained in the one or more electronically-stored existing case record, and identify one or more locations of interest relevant to the interview; determine that one or more mobile imaging device(s) is available prior to the start of the interview window. An output port, coupled to the one or more electronic processors, is configured to output instructions to cause the one or more available mobile imaging device(s) to be deployed to the one or more locations of interest prior to a start of the interview window.

In some examples, the electronic scheduling digital assistant is configured to automate preparations in an intervening period between an incident and a scheduled interview time, in order to gather relevant and time-sensitive information in advance of the interview (thereby saving time, human effort and improving the chances of capturing evidence before it is lost, as well as facilitating a much more useful interview with access to real-time information).

In some examples, the electronic scheduling digital assistant is configured to schedule resources to an incident location to facilitate a much more useful interview with an interviewee at a scheduled interview time, in order to gather relevant and time-sensitive information for the interview and/or validate/confirm or disprove statements made during the interview in a substantially real-time manner (thereby saving time, human effort and improving the chances of capturing evidence before it is lost).

In some examples, the electronic scheduling digital assistant is configured to determine, allocate and instruct a resource to be deployed to locations of interest prior to the interview, where a presence of a mobile video or camera resource (or the data collected in the area) being able to be used to facilitate a level of real-time interactive interviewing has so far been difficult or impossible to achieve.

Although an interview room may allow investigators to quickly jump between virtual scenes of interest with persons of interest using pictures of an incident scene, in some examples the ability to receive and control live video at a time of the interview may be very useful to the interviewer, preferably close to the time of the incident or even the same time of day (e.g., 24 or 48 hours after the incident) to see, for example, actual conditions at the incident.

It is envisaged that the examples herein described may find many applications. For example, an incident may have happened during the day, whilst a live interview might alternatively be happening at night. Alternatively, an incident may have happened during the night, whilst a live interview might be happening during the day; and it is important to obtain data related to the actual time of the incident. Hence, examples facilitate an ability to schedule resource to an incident location at a suitable time, for example on a following day to match the time, lighting, conditions, shadows that were prevalent at the time of the incident. Video recordings from the same time of the incident may provide additional information to the interviewer regarding, say, lighting, shadows, locations of parked vehicles that could also have changed as well.

Each of the above-mentioned embodiments will be discussed in more detail below, starting with example communication system and device architectures of the system in which the embodiments may be practiced, followed by an illustration of processing steps for achieving the method, device, and system for an electronic scheduling digital assistant. Further advantages and features consistent with this disclosure will be set forth in the following detailed description, with reference to the figures.

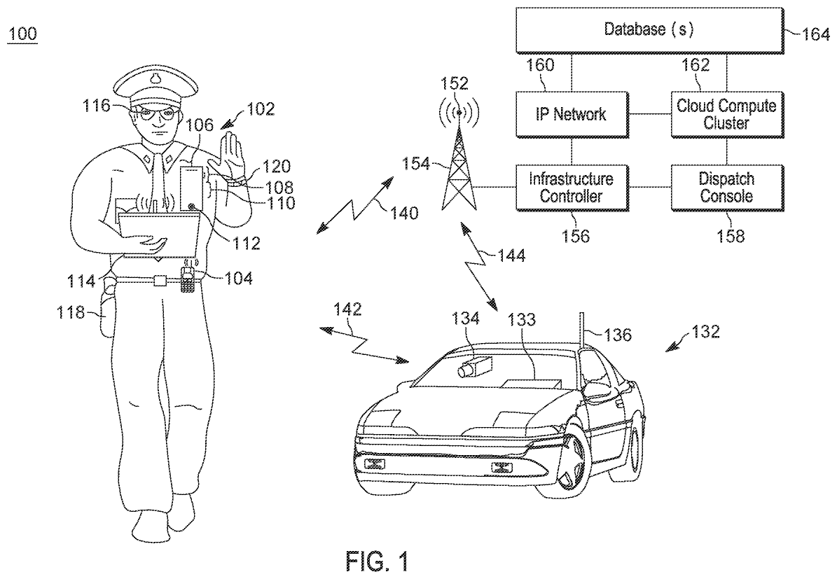

Referring now to the drawings, and in particular FIG. 1, a diagram illustrates a communication system 100 of devices including a first set of devices that a user 102 (illustrated in FIG. 1 as a first responder law enforcement officer) may wear, such as a primary battery-powered portable radio 104 used for narrowband and/or broadband direct-mode or infrastructure communications, a battery-powered radio speaker microphone (RSM) video capture device 106, a laptop 114 having an integrated video camera and used for data applications such as incident support applications, smart glasses 116 (e.g., which may be virtual reality, augmented reality, or mixed reality glasses), sensor-enabled holster 118, and/or biometric sensor wristband 120. Although FIG. 1 illustrates only a single user 102 with a respective first set of devices, in other embodiments, the single user 102 may include additional sets of same or similar devices, and additional users may be present with respective additional sets of same or similar devices (wherein the single user 102 and the additional users may form a talkgroup of related users).

System 100 may also include a vehicle 132 associated with the single user 102 having an integrated mobile communication device 133, an associated vehicular video camera 134, and a coupled vehicular transceiver 136. Although FIG. 1 illustrates only a single vehicle 132 with a single mobile communication device 133, respective single vehicular video camera 134 and/or microphone, single coupled vehicular transceiver 136, and single speaker, in other embodiments, the vehicle 132 may include additional same or similar mobile communication devices, video cameras, microphones, speakers, and/or transceivers, and additional vehicles may be present with respective additional sets of mobile communication devices, video cameras, speakers, microphones, and/or transceivers.

Although this example indicates potential available mobile imaging device(s) to be deployed to the one or more locations of interest being a public safety officer/user 102 or a public safety vehicle 132, a skilled artisan will appreciate that similar communications and technologies exist in air-borne mobile imaging device(s) to be deployed, including (but not limited to) helicopters and drones. Hence, hereafter, the operations of mobile imaging device(s) is/are described with respect to a public safety officer/user 102 or a public safety vehicle 132 and intended to encompass any alternative mobile imaging device(s) that is available to the scheduling computing device.

In some examples, a scheduling computing device, for example located in or connected to a communication hub in or near the interview room may determine that one or more mobile imaging device(s), such as the first responder law enforcement officer/user 102 that wears or carries a video capture device 106 or a vehicular video camera 134, is available prior to the start of the interview window and in the vicinity of the identified incident location.

Each of the portable radio 104, RSM video capture device 106, laptop 114, and vehicular mobile communication device 133 may be capable of directly wirelessly communicating via direct-mode wireless link(s) 142, and/or may be capable of wirelessly communicating via a wireless infrastructure radio access network (RAN) 152 over respective wireless link(s) 140, 144 and via corresponding transceiver circuits, for example to/from the scheduling computing device, which may be located in or connected to a communication hub that is in or near the interview room. These devices may be referred to as communication devices and are configured to receive inputs associated with the user 102 and/or provide outputs to the user 102 in addition to communicating information to and from other communication devices via the infrastructure RAN 152.

The portable radio 104, in particular, may be any communication device used for infrastructure RAN or direct-mode media (e.g., voice, audio, video, messages, etc.) communication via a long-range wireless transmitter and/or transceiver that has a transmitter transmit range on the order of miles, e.g., 0.5-50 miles, or 3-20 miles (i.e., long-range in comparison to a short-range transmitter, such as a Bluetooth™, Zigbee™, or near-far communication (NFC) transmitter) with other communication devices and/or the infrastructure RAN 152. The long-range transmitter may implement a direct-mode, conventional, or trunked land mobile radio (LMR) standard or protocol such as European Telecommunications Standards Institute (ETSI™) Digital Mobile Radio (DMR), a Project 25 (P25) standard defined by the Association of Public Safety Communications Officials International (APCO), Terrestrial Trunked Radio (TETRA™), or other LMR radio protocols or standards. In other embodiments, the long range transmitter may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VOIP), a Long-term evolved (LTE™) Direct or LTE Device to Device, or a PTT over IP (PoIP) application may be implemented. In still further embodiments, the long-range transmitter may implement a Wi-Fi protocol perhaps in accordance with an IEEE 802.11 standard (e.g., 802.11a, 802.11b, 802.11g) or a WiMAX™ protocol perhaps operating in accordance with an IEEE 802.16 standard.

In the example of FIG. 1, the portable radio 104 may form the hub of communication connectivity for the user 102, through which other accessory devices, such as a biometric sensor (for example, the biometric sensor wristband 120), an activity tracker, a weapon status sensor (for example, the sensor-enabled holster 118), a heads-up-display (for example, the smart glasses 116), the RSM video capture device 106, and/or the laptop 114 may communicatively couple.

In order to communicate with and exchange video, audio, and other media and communications with the RSM video capture device 106, laptop 114, and/or smart glasses 116, the portable radio 104 may contain one or more physical electronic ports (such as a universal serial bus (USB) port, an Ethernet port, an audio jack, etc.) for direct electronic coupling with the RSM video capture device 106, laptop 114, and/or smart glasses 116. In some embodiments, the portable radio 104 may contain a short-range transmitter (i.e., short-range in comparison to the long-range transmitter such as a LMR or broadband transmitter) and/or transceiver for wirelessly coupling with the RSM video capture device 106, laptop 114, and/or smart glasses 116. The short-range transmitter may be a Bluetooth, Zigbee, or NFC transmitter having a transmit range on the order of 0.01-100 meters, or 0.1-10 meters. In other embodiments, the RSM video capture device 106, the laptop 114, and/or the smart glasses 116 may contain their own long-range transceivers and may communicate with one another and/or with the infrastructure RAN 152 or vehicular transceiver 136 directly without passing through portable radio 104.

The RSM video capture device 106 provides voice functionality features similar to a traditional RSM, including one or more of acting as a remote microphone that is closer to the user's 102 mouth, providing a remote speaker allowing playback of audio closer to the user's 102 ear, and including a PTT switch or other type of PTT input. The voice and/or audio recorded at the remote microphone may be provided to the portable radio 104 for storage and/or analysis or for further transmission to other mobile communication devices or the infrastructure RAN 152, or may be directly transmitted by the RSM video capture device 106 to other communication devices or to the infrastructure RAN 152. The voice and/or audio played back at the remote speaker may be received from the portable radio 104 or received directly from one or more other communication devices or the infrastructure RAN 152. The RSM video capture device 106 may include a separate physical PTT switch 108 that functions, in cooperation with the portable radio 104 or on its own, to maintain the portable radio 104 and/or RSM video capture device 106 in a monitor only mode, and which switches the device(s) to a transmit-only mode (for half-duplex devices) or transmit and receive mode (for full-duplex devices) upon depression or activation of the PTT switch 108. The portable radio 104 and/or RSM video capture device 106 may form part of a group communications architecture that allows a single communication device to communicate with one or more group members (i.e., talkgroup members not shown in FIG. 1) associated with a particular group of devices at a same time.

Additional features may be provided at the RSM video capture device 106 as well. For example, a display screen 110 may be provided for displaying images, video, and/or text to the user 102 or to someone else. The display screen 110 may be, for example, a liquid crystal display (LCD) screen or an organic light emitting display (OLED) display screen. In some embodiments, a touch sensitive input interface may be incorporated into the display screen 110 as well, allowing the user 102 to interact with content provided on the display screen 110. A soft PTT input may also be provided, for example, via such a touch interface.

A video camera 112 may also be provided at the RSM video capture device 106, integrating an ability to capture images and/or video and store the captured image data (for further analysis) or transmit the captured image data as an image or video stream to the portable radio 104 and/or to other communication devices or to the infrastructure RAN 152 directly. The video camera 112 and RSM remote microphone may be used, for example, for capturing audio and/or video of a field-of-view associated with the user, perhaps including a suspect and the suspect's surroundings, storing the captured image and/or audio data for further analysis or transmitting the captured audio and/or video data as an audio and/or vide stream to the portable radio 104 and/or to other communication devices or to the infrastructure RAN 152 directly for further analysis. An RSM remote microphone of the RSM video capture device 106 may be an omni-directional or unidirectional microphone or array of omni-directional or unidirectional microphones that may be capable of identifying a direction from which a captured sound emanated.

In some embodiments, the RSM video capture device 106 may be replaced with a more limited body worn camera that may include the video camera 112 and/or microphone noted above for capturing audio and/or video, but may forego one or more of the features noted above that transform the body worn camera into a more full featured RSM, such as the separate physical PTT switch 108 and the display screen 110, remote microphone functionality for voice communications in cooperation with portable radio 104, and remote speaker.

The laptop 114, in particular, may be any wireless communication device used for infrastructure RAN or direct-mode media communication via a long-range or short-range wireless transmitter with other communication devices and/or the infrastructure RAN 152. The laptop 114 includes a display screen for displaying a user interface to an operating system and one or more applications running on the operating system, such as a broadband PTT communications application, a web browser application, a vehicle history database application, a workflow application, a forms or reporting tool application, an arrest record database application, an outstanding warrant database application, a mapping and/or navigation application, a health information database application, and/or other types of applications that may require user interaction to operate. The laptop 114 display screen may be, for example, an LCD screen or an OLED display screen. In some embodiments, a touch sensitive input interface may be incorporated into the display screen as well, allowing the user 102 to interact with content provided on the display screen. A soft PTT input may also be provided, for example, via such a touch interface.

Front and/or rear-facing video cameras may also be provided at the laptop 114, integrating an ability to capture video and/or audio of the user 102 and the user's 102 surroundings, perhaps including a field-of-view of the user 102 and/or a suspect (or potential suspect) and the suspect's surroundings, and store and/or otherwise process the captured video and/or audio for further analysis or transmit the captured video and/or audio as a video and/or audio stream to the portable radio 104, other communication devices, and/or the infrastructure RAN 152 for further analysis.

An in-ear or over-the ear earpiece or headphone may be present for providing audio to the user in a private fashion that is not accessible to other users nearby the user 102. The earpiece or headphone may be wiredly or wirelessly communicatively coupled to one or both of the RSM 106 and the portable radio 104, which may be configured to provide audio received from the RAN 152 and/or from other users to the user 102 based on a manual configuration of the RSM 106 or the portable radio 104, or based on some automatic routing mechanism at the one of the RSM 106 and the portable radio 104 that may route all audio to the earpiece or headphone whenever it is detected as connected to the one of the RSM 106 and the portable radio 104, or may selectively route audio received at the one of the RSM 106 and the portable radio 104 to the earpiece or headphone based on various contextual parameters, such as a content of the received audio, an identity of who sent the received audio, a covert status of the user 102, an incident status of the user 102, a determination of nearby users associated with the user 102, or some other contextual parameter.

The smart glasses 116 may include a digital imaging device, an electronic processor, a short-range and/or long-range transceiver device, and/or a projecting device. The smart glasses 116 may maintain a bi-directional connection with the portable radio 104 and provide an always-on or on-demand video feed pointed in a direction of the user's 102 gaze via the digital imaging device, and/or may provide a personal display via the projection device integrated into the smart glasses 116 for displaying information such as text, images, or video received from the portable radio 104 or directly from the infrastructure RAN 152. In some embodiments, the smart glasses 116 may include its own long-range transceiver and may communicate with other communication devices and/or with the infrastructure RAN 152 or vehicular transceiver 136 directly without passing through portable radio 104. In other embodiments, an additional user interface mechanism, such as a touch interface or gesture detection mechanism may be provided at the smart glasses 116 that allows the user 102 to interact with the display elements displayed on the smart glasses 116 or projected into the user's 102 eyes, or to modify operation of the digital imaging device. In still other embodiments, a display and input interface at the portable radio 104 may be provided for interacting with smart glasses 116 content and modifying operation of the digital imaging device, among other possibilities.

The smart glasses 116 may provide a virtual reality interface in which a computer-simulated reality electronically replicates an environment with which the user 102 may interact. In some embodiments, the smart glasses 116 may provide an augmented reality interface in which a direct or indirect view of real-world environments in which the user is currently disposed are augmented (i.e., supplemented, by additional computer-generated sensory input such as sound, video, images, graphics, global positioning system (GPS) data, or other information). In still other embodiments, the smart glasses 116 may provide a mixed reality interface in which electronically generated objects are inserted in a direct or indirect view of real-world environments in a manner such that they may co-exist and interact in real time with the real-world environment and real world objects.

The sensor-enabled holster 118 may be an active (powered) or passive (non-powered) sensor that maintains and/or provides state information regarding a weapon or other item normally disposed within the user's 102 sensor-enabled holster 118. The sensor-enabled holster 118 may detect a change in state (presence to absence) and/or an action (removal) relative to the weapon normally disposed within the sensor-enabled holster 118. The detected change in state and/or action may be reported to the portable radio 104 via its short-range transceiver. In some embodiments, the sensor-enabled holster 118 may also detect whether the first responder's hand is resting on the weapon even if it has not yet been removed from the holster and provide such information to portable radio 104. It is envisaged that other possibilities exist as well.

The biometric sensor wristband 120 may be an electronic device for tracking an activity of the user 102 or a health status of the user 102, and may include one or more movement sensors (such as an accelerometer, magnetometer, and/or gyroscope) that may periodically or intermittently provide to the portable radio 104 indications of orientation, direction, steps, acceleration, and/or speed, and indications of health such as one or more of a captured heart rate, a captured breathing rate, and a captured body temperature of the user 102, perhaps accompanying other information. In some embodiments, the biometric sensor wristband 120 may include its own long-range transceiver and may communicate with other communication devices and/or with the infrastructure RAN 152 or vehicular transceiver 136 directly without passing through portable radio 104.

An accelerometer is a device that measures acceleration. Single and multi-axis models are available to detect magnitude and direction of the acceleration as a vector quantity, and may be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing.

The heart rate sensor may use electrical contacts with the skin to monitor an electrocardiography (EKG) signal of its wearer, or may use infrared light and imaging device to optically detect a pulse rate of its wearer, among other possibilities.

A breathing rate sensor may be integrated within the sensor wristband 120 itself, or disposed separately and communicate with the sensor wristband 120 via a short range wireless or wired connection. The breathing rate sensor may include use of a differential capacitive circuits or capacitive transducers to measure chest displacement and thus breathing rates. In other embodiments, a breathing sensor may monitor a periodicity of mouth and/or nose-exhaled air (e.g., using a humidity sensor, temperature sensor, capnometer or spirometer) to detect a respiration rate. It is envisaged that other possibilities exist as well.

A body temperature sensor may include an electronic digital or analog sensor that measures a skin temperature using, for example, a negative temperature coefficient (NTC) thermistor or a resistive temperature detector (RTD), may include an infrared thermal scanner module, and/or may include an ingestible temperature sensor that transmits an internally measured body temperature via a short range wireless connection, among other possibilities.

Although the biometric sensor wristband 120 is shown in FIG. 1 as a bracelet worn around the wrist, in other examples, the biometric sensor wristband 120 may additionally and/or alternatively be worn around another part of the body, or may take a different physical form including an earring, a finger ring, a necklace, a glove, a belt, or some other type of wearable, ingestible, or insertable form factor.

The portable radio 104, RSM video capture device 106, laptop 114, smart glasses 116, sensor-enabled holster 118, and/or biometric sensor wristband 120 may form a personal area network (PAN) via corresponding short-range PAN transceivers, which may be based on a Bluetooth, Zigbee, or other short-range wireless protocol having a transmission range on the order of meters, tens of meters, or hundreds of meters.

The portable radio 104 and/or RSM video capture device 106 (or any other electronic device in FIG. 1, for that matter) may each include a location determination device integrated with or separately disposed in the portable radio 104 and/or RSM 106 and/or in respective receivers, transmitters, or transceivers of the portable radio 104 and RSM 106 for determining a location of the portable radio 104 and RSM 106. The location determination device may be, for example, a global positioning system (GPS) receiver or wireless triangulation logic using a wireless receiver or transceiver and a plurality of wireless signals received at the wireless receiver or transceiver from different locations, among other possibilities. The location determination device may also include an orientation sensor for determining an orientation that the device is facing. Each orientation sensor may include a gyroscope and/or a magnetometer. Other types of orientation sensors could be used as well. The location may then be stored locally or transmitted via the transmitter or transceiver to other communication devices and/or to the infrastructure RAN 152.

In example embodiments, the location information is communicated back to the interviewer in the interview room prior to the start of the interview, for example in order to confirm or refute any statements that are made during the interview. In some examples, the interview room's purpose is not primarily about collecting evidence, but about enhancing or cross-checking witness statements by creating a proxy for going back in time and walking a witness through the “scenes” of the incidents that are linked to a crime. For example, this process can advantageously prompt memories of more leads to be corroborated or explored than might otherwise be captured in initial witness statements. In some examples, resources may be scheduled to an incident location to obtain ‘secondary evidence’, in a non-first responder role for a law enforcement officer, in order to facilitate a much more useful interview with an interviewee at a scheduled interview time. The ability to gather relevant and time-sensitive information for the interview and/or validate/confirm or disprove statements made during the interview in a substantially real-time manner saves time, human effort and improves the chances of capturing evidence before it is lost.

In some examples, the interviewer (located in an interview room) may be interactively shown a live or recorded video in the interview room, following a pre-interview scheduling of resources to obtain video images at an incident location, for example. In this manner, the interviewer may adopt a role of a video production engineer (where(s) he may be able to share or privately view images coming from multiple sources, some of which may be live).

In an envisaged practical scenario according to some examples, an interviewee may repeatedly describe a scenario that does not match what the interviewer is viewing in video evidence (either live or recorded) being collected by the scheduled cameras or recorded video, so the interviewer then is provided with the opportunity to confront the interviewee with jointly viewed video to get to a truthful representation of facts at the incident. In some examples, the interviewer may be provided, prior to or at a beginning of the interview window, determined locations of interest to which the one or more mobile imaging devices have been deployed with at least a portion of the one or more electronically-stored existing case records from which the locations of interest were identified.

In an envisaged practical live video scenario according to some examples, a law enforcement officer who has a patrol beat around the time of the interview, and stationed near one of the locations of interest, can be asked by the interviewer to move to a specific location, or peer under something, or around the corner, etc. with the BWC (body worn camera) steered to capture video of interest.

The vehicle 132 associated with the user 102 may include the mobile communication device 133, the vehicular video camera 134 and/or microphone, and the vehicular transceiver 136, all of which may be coupled to one another via a wired and/or wireless vehicle area network (VAN), perhaps along with other sensors physically or communicatively coupled to the vehicle 132. The vehicular transceiver 136 may include a long-range transceiver for directly wirelessly communicating with communication devices such as the portable radio 104, the RSM 106, and the laptop 114 via wireless link(s) 142 and/or for wirelessly communicating with the RAN 152 via wireless link(s) 144. The vehicular transceiver 136 may further include a short-range wireless transceiver or wired transceiver for communicatively coupling between the mobile communication device 133 and/or the vehicular video camera 134 in the VAN. The mobile communication device 133 may, in some embodiments, include the vehicular transceiver 136 and/or the vehicular video camera 134 integrated therewith, and may operate to store and/or process video and/or audio produced by the video camera 134 and in example embodiments transmit the captured video and/or audio as a video and/or audio stream to the portable radio 104, other communication devices, and/or to the interview room via the infrastructure RAN 152 for further analysis or real-time viewing prior to the start of the interview. The omni-directional or unidirectional microphone, or an array thereof, may be integrated in the video camera 134 and/or at the vehicular computing device 133 (or additionally or alternatively made available at a separate location of the vehicle 132) and communicably coupled to the vehicular computing device 133 and/or vehicular transceiver 136 for capturing audio and storing, processing, and/or transmitting the audio in a same or similar manner as set forth above with respect to the RSM 106.

Although FIG. 1 illustrates the vehicular video camera 134 and microphone as being placed inside the vehicle 132, in other embodiments, one or both of the vehicular video camera 134 and microphone may be placed at visible or hidden locations outside of the vehicle 132, such as within a vehicular grill portion or bumper portion, or on a roof portion, of the vehicle 132. Further, although FIG. 1 illustrates the single speaker as being placed inside of the vehicle 132 and coupled to the vehicular computing device 133, in other embodiments, multiple speakers may be provided inside and/or outside of the vehicle 132 (all addressed simultaneously or individually addressable for outputting separate audio streams), or the single speaker may be placed outside of the vehicle and function as a PA speaker, among other possibilities.

The vehicle 132 may be a human-operable vehicle, or may be a self-driving vehicle operable under control of mobile communication device 133 perhaps in cooperation with video camera 134 (which may include a visible-light camera, an infrared camera, a time-of-flight depth camera, and/or a light detection and ranging (LiDAR) device). Command information and/or status information such as location and speed may be exchanged with the self-driving vehicle via the VAN and/or the PAN (when the PAN is in range of the VAN or via the VAN's infrastructure RAN link).

The vehicle 132 and/or transceiver 136, similar to the portable radio 104 and/or respective receivers, transmitters, or transceivers thereof, may include a location (and/or orientation) determination device integrated with or separately disposed in the mobile communication device 133 and/or transceiver 136 for determining (and storing and/or transmitting) a location (and/or orientation) of the vehicle 132.

In some embodiments, instead of a vehicle 132, a land, air, or water-based drone with the same or similar audio and/or video and communications capabilities and the same or similar self-navigating capabilities as set forth above may be disposed, and may similarly communicate with the user's 102 PAN and/or with the infrastructure RAN 152 to support the user 102 in the field.

The VAN may communicatively couple with the PAN disclosed above when the VAN and the PAN come within wireless transmission range of one another, perhaps after an authentication takes place there between. In some embodiments, one of the VAN and the PAN may provide infrastructure communications to the other, depending on the situation and the types of devices in the VAN and/or PAN and may provide interoperability and communication links between devices (such as video cameras and sensors) within the VAN and PAN.

Although the RSM 106, the laptop 114, and the vehicle 132 are illustrated in FIG. 1 as providing example video cameras and/or microphones for use in capturing audio and/or video streams, other types of cameras and/or microphones could be used as well, including but not limited to, fixed or pivotable video cameras secured to lamp posts, automated teller machine (ATM) video cameras, other types of body worn cameras such as head-mounted cameras, other types of vehicular cameras such as roof-mounted cameras, or other types of audio and/or video recording devices accessible via a wired or wireless network interface same or similar to that disclosed herein.

The information obtained following resources being scheduled to an incident location to obtain ‘secondary evidence’ in order to facilitate a much more useful interview with an interviewee at a scheduled interview time may be sent over the infrastructure RAN 152 to the interview room, say via a dispatcher. Infrastructure RAN 152 is a radio access network that provides for radio communication links to be arranged within the network between a plurality of user terminals. Such user terminals may be portable, mobile, or stationary and may include any one or more of the communication devices illustrated in FIG. 1, among other possibilities. At least one other terminal, e.g., used in conjunction with the communication devices, may be a fixed terminal, e.g., a base station, eNodeB, repeater, and/or access point. Such a RAN typically includes a system infrastructure that generally includes a network of various fixed terminals, which are in direct radio communication with the communication devices. Each of the fixed terminals operating in the RAN 152 may have one or more transceivers which may, for example, serve communication devices in a given region or area, known as a ‘cell’ or ‘site’, by radio frequency (RF) communication. The communication devices that are in direct communication with a particular fixed terminal are said to be served by the fixed terminal. In one example, all radio communications to and from each communication device within the RAN 152 are made via respective serving fixed terminals. Sites of neighboring fixed terminals may be offset from one another and may provide corresponding non-overlapping or partially or fully overlapping RF coverage areas.

Infrastructure RAN 152 may operate according to an industry standard wireless access technology such as, for example, an LTE, LTE-Advance, or 5G technology over which an OMA-PoC, a VoIP, an LTE Direct or LTE Device to Device, or a PoIP application may be implemented. Additionally or alternatively, infrastructure RAN 152 may implement a wireless local area network (WLAN) technology such as Wi-Fi perhaps operating in accordance with an IEEE 802.11 standard (e.g., 802.11a, 802.11b, 802.11g) or such as a WiMAX perhaps operating in accordance with an IEEE 802.16 standard.

Infrastructure RAN 152 may additionally or alternatively operate according to an industry standard LMR wireless access technology such as, for example, the P25 standard defined by the APCO, the TETRA standard defined by the ETSI, the dPMR standard also defined by the ETSI, or the DMR standard also defined by the ETSI. Because these systems generally provide lower throughput than the broadband systems, they are sometimes designated as narrowband RANs.

Communications in accordance with any one or more of these protocols or standards, or other protocols or standards, may take place over physical channels in accordance with one or more of a TDMA (time division multiple access), FDMA (frequency divisional multiple access), OFDMA (orthogonal frequency division multiplexing access), or CDMA (code division multiple access) technique.

OMA-POC, in particular and as one example of an infrastructure broadband wireless application, enables familiar PTT and “instant on” features of traditional half duplex communication devices, but uses communication devices operating over modern broadband telecommunications networks. Using OMA-POC, wireless communication devices such as mobile telephones and notebook computers can function as PTT half-duplex communication devices for transmitting and receiving. Other types of PTT models and multimedia call models (MMCMs) are also available.

Floor control in an OMA-POC session is generally maintained by a PTT server that controls communications between two or more wireless communication devices. When a user of one of the communication devices keys a PTT button, a request for permission to speak in the OMA-POC session is transmitted from the user's communication device to the PTT server using, for example, a real-time transport protocol (RTP) message. If no other users are currently speaking in the PoC session, an acceptance message is transmitted back to the user's communication device and the user may then speak into a microphone of the communication device. Using standard compression/decompression (codec) techniques, the user's voice is digitized and transmitted using discrete auditory data packets (e.g., together which form an auditory data stream over time), such as according to RTP and internet protocols (IP), to the PTT server. The PTT server then transmits the auditory data packets to other users of the PoC session (e.g., to other communication devices in the group of communication devices or talkgroup to which the user is subscribed), using for example, one or more of a unicast, point to multipoint, or broadcast communication technique.

Infrastructure narrowband LMR wireless systems, on the other hand, operate in either a conventional or trunked configuration. In either configuration, a plurality of communication devices is partitioned into separate groups of communication devices. In a conventional narrowband system, each communication device in a group is selected to a particular radio channel (frequency or frequency & time slot) for communications associated with that communication device's group. Thus, each group is served by one channel, and multiple groups may share the same single frequency or frequency & time slot (in which case, in some embodiments, group IDs may be present in the group data to distinguish between groups).

In contrast, a trunked radio system and its communication devices use a pool of traffic channels for virtually an unlimited number of groups of communication devices (and which may also be referred to herein as talkgroups). Thus, all groups are served by all channels. The trunked radio system works to take advantage of the probability that not all groups need a traffic channel for communication at the same time. When a member of a group requests a call on a control or rest channel on which all of the communication devices at a site idle awaiting new call notifications, in one embodiment, a call controller assigns a separate traffic channel for the requested group call, and all group members move from the assigned control or rest channel to the assigned traffic channel for the group call. In another embodiment, when a member of a group requests a call on a control or rest channel, the call controller may convert the control or rest channel on which the communication devices were idling to a traffic channel for the call, and instruct all communication devices that are not participating in the new call to move to a newly assigned control or rest channel selected from the pool of available channels. With a given number of channels, a much greater number of groups may be accommodated in a trunked radio system as compared with a conventional radio system.

Group calls may be made between wireless and/or wireline participants in accordance with either a narrowband or a broadband protocol or standard. Group members for group calls may be statically or dynamically defined. That is, in a first example, a user or administrator working on behalf of the user may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., group call) with each of the pre-designated participants in the defined group. In another example, communication devices may dynamically affiliate with a group (and also disassociate with the group) perhaps based on user input, and the switching and/or radio network may track group membership and route new group calls according to the current group membership.

In some instances, broadband and narrowband systems may be interfaced via a middleware system that translates between a narrowband PTT standard protocol (such as P25) and a broadband PTT standard protocol or application (such as OMA-PoC). Such intermediate middleware may include a middleware server for performing the translations and may be disposed in the cloud, disposed in a dedicated on-premises location for a client wishing to use both technologies, or disposed at a public carrier supporting one or both technologies. For example, and with respect to FIG. 1, such a middleware server may be disposed in infrastructure RAN 152 at infrastructure controller 156 or at a separate cloud computing cluster such as cloud compute cluster 162 communicably coupled to controller 156 via internet protocol (IP) network 160, among other possibilities.

The infrastructure RAN 152 is illustrated in FIG. 1 as providing coverage for the portable radio 104, RSM video capture device 106, laptop 114, smart glasses 116, and/or vehicle transceiver 136 via a single fixed terminal 154 coupled to a single infrastructure controller 156 (e.g., a radio controller, call controller, PTT server, zone controller, MME, BSC, MSC, site controller, Push-to-Talk controller, or other network device) and including a dispatch console 158 operated by a dispatcher. In other embodiments, additional fixed terminals and additional controllers may be disposed to support a larger geographic footprint and/or a larger number of mobile devices or other resources (such as drones, personnel, etc.). In some examples, this controlled approach may avoid over-scheduling resources as part of improving real-time public safety related interviews.

The infrastructure controller 156 illustrated in FIG. 1, or some other back-end infrastructure device or combination of back-end infrastructure devices existing on-premises or in the remote cloud compute cluster 162 accessible via the IP network 160 (such as the Internet), may additionally or alternatively operate as a back-end electronic scheduling digital assistant, a back-end audio and/or video processing device, and/or a remote cloud-based storage device consistent with the remainder of this disclosure. In some examples, the scheduler computing device is configured to output instructions to cause the one or more available mobile imaging device(s) to be deployed to the one or more locations of interest prior to a start of the interview window via the infrastructure controller 156.

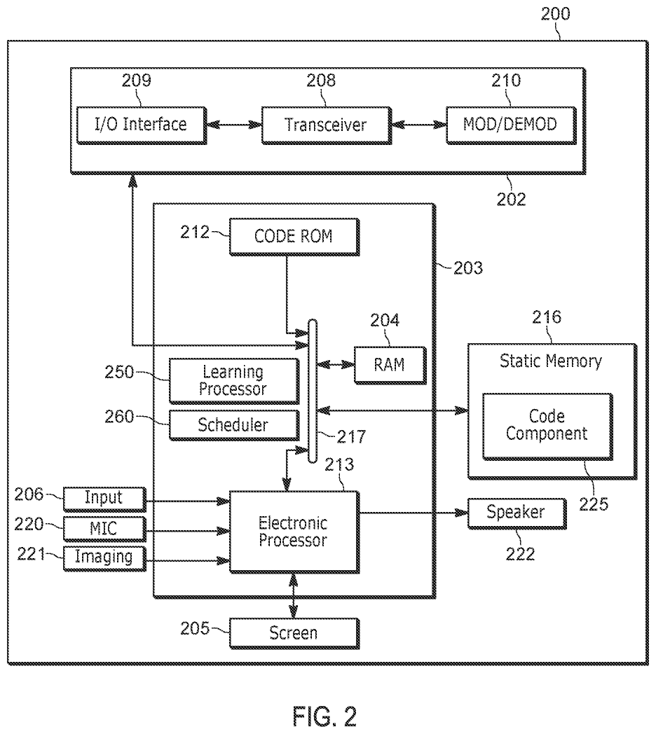

The IP network 160 may comprise one or more routers, switches, local area networks (LANs), WLANs, wide area networks (WANs), access points, or other network infrastructure, including but not limited to, the public Internet. The cloud compute cluster 162 may be comprised of a plurality of computing devices, such as the one set forth in FIG. 2, one or more of which may be executing none, all, or a portion of an electronic scheduling digital assistant service, sequentially or in parallel, across the one or more computing devices. The one or more computing devices comprising the cloud compute cluster 162 may be geographically co-located or may be separated by inches, meters, or miles, and inter-connected via electronic and/or optical interconnects. Although not shown in FIG. 1, one or more proxy servers or load balancing servers may control which one or more computing devices perform any part or all of the electronic scheduling digital assistant service.

Database(s) 164 may be accessible via IP network 160 and/or cloud compute cluster 162, and may include databases such as a long-term video storage database, a historical or forecasted weather database, an offender database perhaps including facial recognition images to match against, a cartographic database of streets and elevations, a traffic database of historical or current traffic conditions, or other types of databases.

In some examples, the scheduler computing device is configured to receive interview scheduling information from database(s) 164, for example accessible via IP network 160 and/or cloud compute cluster 162, wherein the interview scheduling information comprises at least one interview window time parameter associated with an interview window for interviewing an interviewee by an interviewer, the at least one interview window time parameter comprising at least one of: an interview start time, a scheduled end time of an interview, a date of an interview, a minimum duration of an interview.

In some examples, the one or more electronic processors of the scheduler computing device is configured to access, responsive to the at least one interview window time parameter, one or more electronically-stored existing case record associated with the interview stored in database(s) 164 and identifying one or more locations of interest relevant to the interview based on processing the one or more electronically-stored existing case record. In some examples, the one or more electronic processors of the scheduler computing device is configured to determine whether one or more mobile imaging device(s) is available prior to the start of the interview window, such information for example being stored and updated in the database(s) 164, in order to subsequently cause the one or more available mobile imaging device(s) to be deployed to the one or more locations of interest prior to a start of the interview window.

Databases 164 may further include all or a portion of the databases described herein as being provided at infrastructure controller 156. In some embodiments, the databases 164 may be maintained by third parties (for example, the National Weather Service or a Department of Transportation, respectively). As shown in FIG. 1, the databases 164 are communicatively coupled with the infrastructure RAN 152 to allow the communication devices (for example, the portable radio 104, the RSM video capture device 106, the laptop 114, and the mobile communication device 133) to communicate with and retrieve data from the databases 164 via infrastructure controller 156 and IP network 160. In some embodiments, the databases 164 are commercial cloud-based storage devices. In some embodiments, the databases 164 are housed on suitable on-premises database servers. The databases 164 of FIG. 1 are merely examples. In some embodiments, the system 100 additionally or alternatively includes other databases that store different information. In some embodiments, the databases 164 disclosed herein and/or additional or other databases are integrated with, or internal to, the infrastructure controller 156.

Finally, although FIG. 1 describes a communication system 100 generally as a public safety communication system that includes a user 102 generally described as a law enforcement officer and a vehicle 132 generally described as a police car or cruiser, in other embodiments, the communication system 100 may additionally or alternatively be a retail communication system including a user 102 that may be an employee of a retailer and a vehicle 132 that may be a vehicle for use by the user 102 in furtherance of the employee's retail duties (e.g., a shuttle or self-balancing scooter). In other embodiments, the communication system 100 may additionally or alternatively be a warehouse communication system including a user 102 that may be an employee of a warehouse and a vehicle 132 that may be a vehicle for use by the user 102 in furtherance of the employee's retail duties (e.g., a forklift). In still further embodiments, the communication system 100 may additionally or alternatively be a private security communication system including a user 102 that may be an employee of a private security company and a vehicle 132 that may be a vehicle for use by the user 102 in furtherance of the private security employee's duties (e.g., a private security vehicle or motorcycle). In even further embodiments, the communication system 100 may additionally or alternatively be a medical communication system including a user 102 that may be a doctor or nurse of a hospital and a vehicle 132 that may be a vehicle for use by the user 102 in furtherance of the doctor or nurse's duties (e.g., a medical gurney or ambulance). In still another example embodiment, the communication system 100 may additionally or alternatively be a heavy machinery communication system including a user 102 that may be a miner, driller, or extractor at a mine, oil field, or precious metal or gem field and a vehicle 132 that may be a vehicle for use by the user 102 in furtherance of the miner, driller, or extractor's duties (e.g., an excavator, bulldozer, crane, front loader). As one other example, the communication system 100 may additionally or alternatively be a transportation logistics communication system including a user 102 that may be a bus driver or semi-truck driver at a school or transportation company and a vehicle 132 that may be a vehicle for use by the user 102 in furtherance of the driver's duties. In the examples of a user 102 being other than a law enforcement officer, certain sensors such as the weapon status sensor described above with respect to the law enforcement officer user may be replaced or supplemented with other types of sensors, such as one or more sensors that may detect whether a particular retail, warehouse, private security, heavy machinery operator, transportation driver, or other type of user has equipment necessary to perform a particular assigned or to-be-assigned task, whether such equipment is in a workable or sufficient condition, or whether the equipment is sufficient for the area or environment the user is in. It is envisaged that other possibilities and variations exist as well.

FIG. 2 sets forth a schematic diagram that illustrates an example of an electronic scheduling device, such as an electronic scheduling digital assistant 200 configured to communicate with a variety of communication devices, such as a law enforcement officer radio or a drone, according to some embodiments of the present disclosure. The example electronic scheduling digital assistant 200 may be configured, for example, to communicate with the portable radio 104, the RSM video capture device 106, the laptop 114, the mobile communication device 133, the infrastructure controller 156, the dispatch console 158, one or more computing devices in the cloud compute cluster 162, or some other communication device not illustrated in FIG. 1, and/or linked via a wired and/or wireless communication link(s). In some embodiments, the electronic scheduling digital assistant 200 may be communicatively coupled to other devices such as the sensor-enabled holster 118 as described above.

While FIG. 2 represents the electronic scheduling digital assistant 200 described below, it is envisaged that the electronic scheduling digital assistant 200 may include fewer or additional components in configurations different from that illustrated in FIG. 2. For example, in some embodiments, electronic scheduling digital assistant 200 may be operably and communicatively coupled to a separate wireless device comprising the I/O interface 209 and/or a wireless transceiver 208 and/or modulator/demodulator 210, or may be operably and communicatively coupled to a separate user interface device that may (or may not) include one or more of the screen 205, input device 206, microphone 220, imaging device 221, and speaker 222. As another example, in some embodiments, the electronic scheduling digital assistant 200 may be operably and communicatively coupled to the RSM video capture device 106 and may further include a location determination device (for example, a global positioning system (GPS) receiver) as explained above. It is envisaged that other possibilities and combinations exist as well.

In some examples, the scheduling computing device 200 is arranged to improve the effectiveness of public safety/law enforcement officer related interviews, for example by performing pre-work and scheduling resources ahead of a planned interview. In some examples, resources may be scheduled to an incident location to obtain ‘secondary evidence’, from a non-first responder law enforcement officer, in order to facilitate a much more useful interview with an interviewee at a scheduled interview time. The ability to gather relevant and time-sensitive information for the interview and/or validate/confirm or disprove statements made during the interview in a substantially real-time manner saves time, human effort and improves the chances of capturing evidence before it is lost. In some examples, the scheduling computing device 200 includes a receiver (for example the input device 206 and electronic processor 213) configured to receive interview scheduling information, wherein the interview scheduling information comprises at least one interview window time parameter associated with an interview window for interviewing an interviewee by an interviewer, the at least one interview window time parameter comprising at least one of: an interview start time, a scheduled end time of an interview, a date of an interview, a minimum duration of an interview. One or more electronic processor units 203, 213, 250 operably coupled to the receiver or comprising functionality to process received data, is/are configured to: access, responsive to the at least one interview window time parameter, one or more electronically-stored existing case record associated with the interview; process information contained in the electronically-stored case record, and identifying one or more locations of interest relevant to the interview; and determine that one or more mobile imaging device(s) is available prior to the start of the interview window. Upon determining that one or more mobile imaging device(s) is available prior to the start of the interview window, a scheduler coupled to or forming a part of the one or more electronic processor units 203, 213, 250 is configured to output instructions to cause the one or more available mobile imaging device(s) to be deployed to the one or more locations of interest prior to a start of the interview window an interview window.

As shown in FIG. 2, the electronic scheduling digital assistant 200 may include a communications unit 202 coupled to a common data and address bus 217 of a processing unit 203. The electronic scheduling digital assistant 200 may also include one or more input devices (e.g., keypad, pointing device, touch-sensitive surface, etc.) 206 and an electronic display screen 205 (which, in some embodiments, may be a touch screen and thus also act as an input device 206), each coupled to be in communication with the processing unit 203.

The microphone 220 may be present for capturing audio from a user and/or other environmental or background audio that is further processed by processing unit 203 in accordance with the remainder of this disclosure and/or is transmitted as voice or audio stream data, or as acoustical environment indications, by communications unit 202 to other portable radios and/or other communication devices. The imaging device 221 may provide video (still or moving images) of an area in a field of view of a communication device for further processing by the processing unit 203 and/or for further transmission by the communications unit 202. A speaker 222 may be present for reproducing audio that is decoded from voice or audio streams of calls received via the communications unit 202 from other portable radios, from digital audio stored at the electronic scheduling digital assistant 200 may, from other ad-hoc or direct mode devices, and/or from an infrastructure RAN device, or may playback alert tones or other types of pre-recorded audio.

The processing unit 203 may include a code Read Only Memory (ROM) 212 coupled to the common data and address bus 217 for storing data for initializing system components. The processing unit 203 may further include an electronic processor 213 (for example, a microprocessor or another electronic device) coupled, by the common data and address bus 217, to a Random Access Memory (RAM) 204 and a static memory 216.

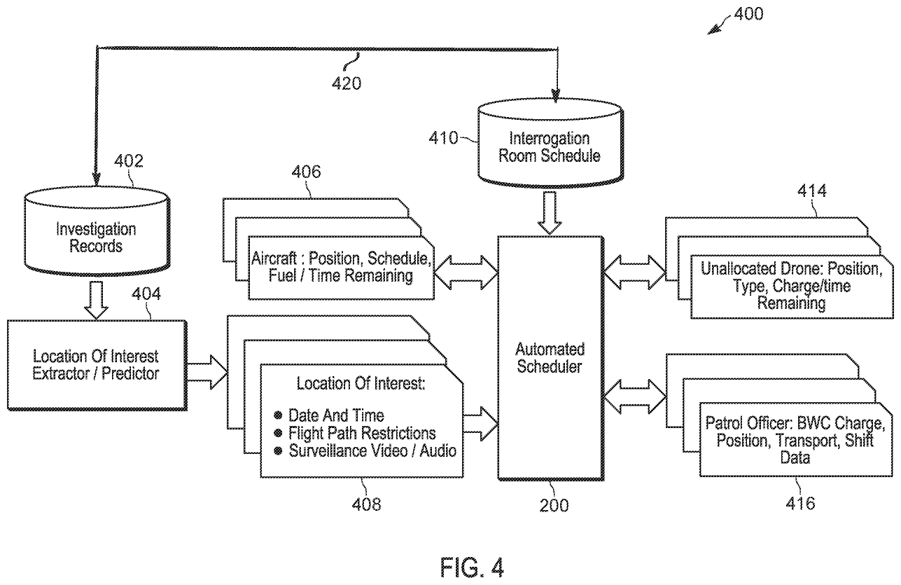

In some examples, the one or more electronic processor units 203, 213, 250 of the scheduler computing device 200 is configured to access, responsive to a received at least one interview window time parameter, one or more electronically-stored existing case records associated with the interview stored in a locally stored RAM 204 (for example a RAM 204 that tracks interview room use and scheduling stored in database(s) 164 of FIG. 1). In some examples, the one or more electronically-stored existing case records may include investigation records (see investigation records 402 in FIG. 4), which may include a unique investigation identifier and a structure that would allow a single investigation to be split into, say, two, or alternatively for two seemingly unrelated investigations to be merged upon discovery that they are related. In some examples, this approach may contain initially known events at that time and/or at a location (e.g., at 7:15 am, Miss Scarlet reported finding the body of Professor Plum on the steps of City Hall—he appeared to have been shot). In some examples, this approach may also identify a number or all individuals involved with the case/investigation, including witnesses, investigators, suspects, and any other persons of interest as well as contextual information, such as when they made their statements and where they reported they were at those times. In some examples, an inference engine (such as inference engine 404 in FIG. 4) may serve as a location of interest extractor/predictor and may examine or infer secondary locations of interest derived from the submitted statements or other evidence (a new person of interest placed at a scene/location of interest as established by, say, facial recognition in video evidence, for example). An example of location information is shown in Table 404B below as a partial example of the output from this engine (inference engine 404). In some examples, the one or more electronic processor units 203, 213, 250 of the scheduler computing device 200 is/are configured to determine whether one or more mobile imaging device(s) is available prior to the start of the interview window, such information for example also being stored and updated in RAM 204 (for example to track the database(s) 164 in FIG. 1), in order to subsequently cause the one or more available mobile imaging device(s) to be deployed to the one or more locations of interest prior to a start of the interview window.

The communications unit 202 may include one or more wired and/or wireless input/output (I/O) interfaces 209 that are configurable to communicate with other communication devices, such as the portable radio 104, the laptop 114, the wireless RAN 152, and/or the mobile communication device 133.

For example, the communications unit 202 may include one or more wireless transceivers 208, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), an LTE transceiver, a WiMAX™ transceiver perhaps operating in accordance with an IEEE 802.16 standard, and/or another similar type of wireless transceiver configurable to communicate via a wireless radio network.

The communications unit 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

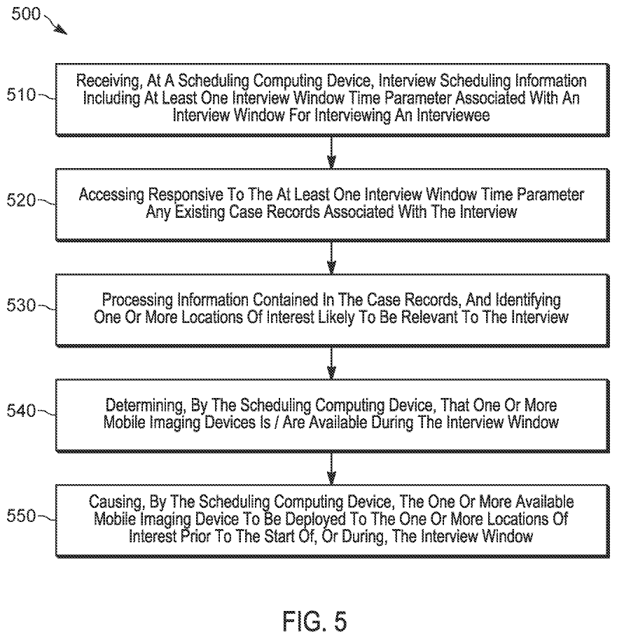

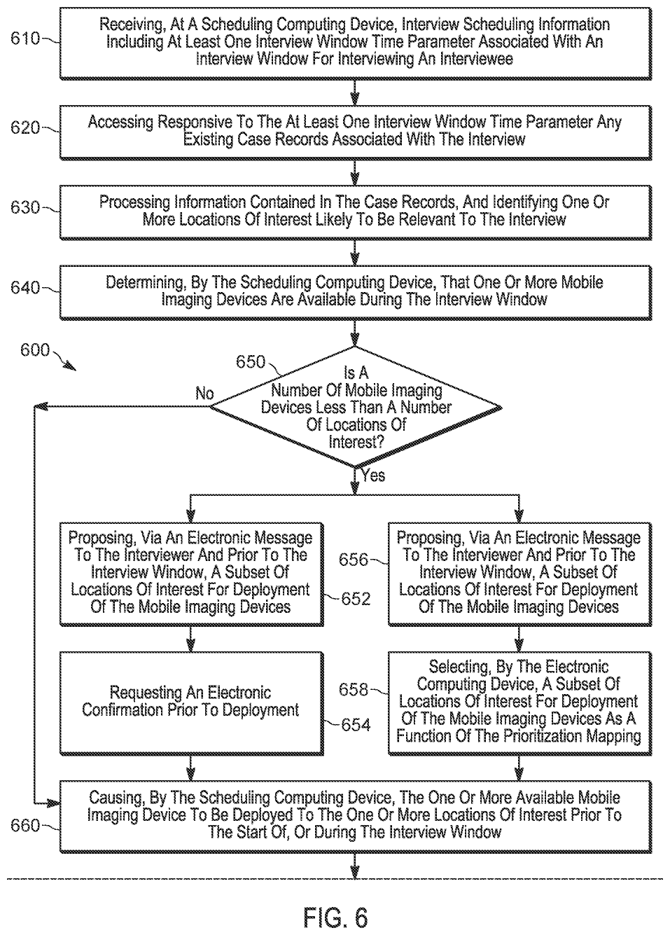

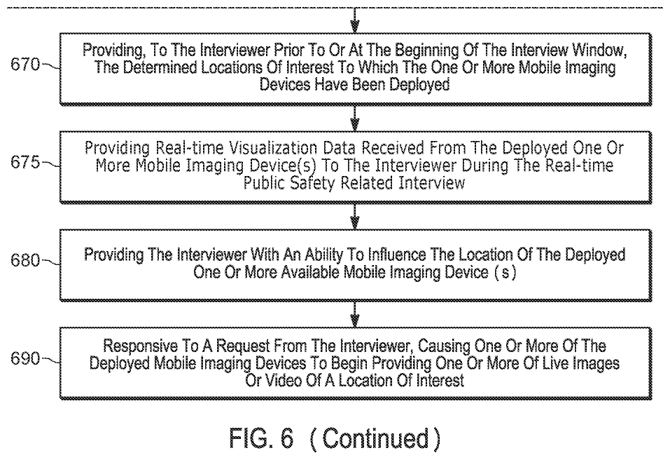

The electronic processor 213 has ports for coupling to the display screen 205, the input device 206, the microphone 220, the imaging device 221, and/or the speaker 222. Static memory 216 may store operating code 225 for the electronic processor 213 that, when executed, performs one or more of the steps set forth in FIG. 5 and FIG. 6 and accompanying text.

In some embodiments, static memory 216 may also store, permanently or temporarily, one or more electronically-stored existing case record associated with the interview, and/or whether one or more mobile imaging device(s) is available prior to the start of the interview window, including, for example, a last known location of the one or more mobile imaging device(s).

The static memory 216 may comprise, for example, a hard-disk drive (HDD), an optical disk drive such as a compact disk (CD) drive or digital versatile disk (DVD) drive, a solid state drive (SSD), a flash memory drive, or a tape drive, and the like.

In some embodiments, an individual component and/or a combination of individual components of the system 100 may be referred to as an electronic computing device that implements an electronic scheduling digital assistant as mentioned above. For example, the electronic computing device may be a single electronic processor (for example, the electronic processor 213). In other embodiments, the electronic computing device includes multiple electronic processors distributed remotely from each other. For example, the electronic computing device may be implemented on a combination of at least two of the electronic processor 213, an electronic processor of a back-end cloud compute cluster 162 accessible via the IP network 160.

To use the electronic scheduling digital assistant implemented by the electronic computing device, a user may, for example, provide an oral query or statement that is received by the microphone 220 of the electronic scheduling digital assistant 200. The electronic computing device receives signals representative of the oral query or statement from the microphone 220 and analyzes the signals to determine the content of the oral query or statement. For example, the electronic computing device may include a natural language processing (NLP) engine configured to determine the intent and/or content of the oral query or statement. The electronic computing device may also be configured to determine a response to the oral query (for example, by retrieving stored data or by requesting data from a database such as one of the databases 164) and provide the response to an output device of the electronic scheduling digital assistant 200 (for example, one or more of the speaker 222 via a generated audio response and the screen 205 via a generated text based response), and/or may be configured to determine some other action to taken in light of the content of the oral query and/or statement. In other words, the electronic scheduling digital assistant 200 may include an NLP engine to analyze oral queries and/or statements received by the microphone 220 of the electronic scheduling digital assistant 200 and provide responses to the oral queries and/or take other actions in response to the oral statements.

Although an oral query and/or statement is described above, in some embodiments, the electronic computing device receives and responds to other types of queries and inputs. For example, the user 102 may submit a text query to the electronic computing device by typing the text query into a hard keyboard input device 206 or a soft keyboard input provided on the screen 205 of the electronic scheduling digital assistant 200. As another example, the user 102 may use the imaging device 221 to capture an image or video of an area and press a hard or soft key to send the image or video to the electronic computing device to, for example, allow the electronic computing device to identify an object in the image or video and provide a response and/or take other actions. In still other examples, the electronic computing device may have access to other databases such as calendar or e-mail databases associated with the user 102, and may take an action as a function of some other asynchronous trigger such as receipt and processing of an upcoming calendar entry appointment associated with the user 102 or receipt of an e-mail associated with the user 102 including generating and providing an unsolicited output to an output device of the electronic scheduling digital assistant 200 (for example, one or more of the speaker 222 via a generated audio response and the screen 205 via a generated text based response).

In some examples, the electronic scheduling digital assistant 200 may include a learning processor 250, which may be configured to employ artificial intelligence or neural network behavior on the information provided thereto. In some examples, the learning processor 250 may be provided with data related to a public safety incident, including information such as street maps and/or available resources, such as public safety officer locations in a vicinity of the public safety incident or drone availability, etc. In this manner, the learning processor 250 may be configured to determine locations of interest, say from already gathered information that may include but is not limited to incident data, officer reports, call recordings, witness testimony, etc.

In some examples the learning processor 250 may be configured to function as a scheduler 260 arranged to schedule, for example, deployment of resources automatically, which may include deploy resources from various data sources, such as traffic cameras, surveillance cameras, police reports, witness testimony, audio recording, or any combination thereof, and would coordinate availability for supporting interview activities, where the data sources may include location identities of public safety officers (for example having a BWC) in the vicinity of an incident, a known location of a public safety vehicle; an availability and/or location of one or more air-borne resource(s), such as helicopters, drones, etc. In some examples the learning processor 250 may be configured to cause the one or more mobile imaging devices to be deployed to the one or more locations of interest prior to the start of the interview window comprises causing multiple available mobile imaging devices of differing types (e.g., public safety officers, public safety vehicles, drones, airborne units, etc.) to the one or more locations of interest.

In some examples the learning processor 250 may be configured to coordinate with onsite personnel to utilize in field resources (e.g. drones, personnel, vehicles, etc.) to gather audio, video or pictures of locations of interest at approximately the same time of day of the incident to offer the interviewer a better idea of the conditions (e.g. lighting, objects in the vicinity, etc.) from a variety of perspectives (e.g., eye level video/pictures from various angles, birds eye view, etc.). In some examples, the interviewer may be provided with, prior to or at a beginning of the interview window, determined locations of interest to which the one or more mobile imaging devices have been deployed with at least a portion of the one or more electronically-stored existing case records from which the locations of interest were identified. The gathered information can then be correlated with an interviewer's planning in order to provide a better and more productive/incisive interview experience.

In some examples the learning processor 250 may be configured to manage resources, which may include durability/endurance of any mobile units deployed to obtain information pertinent to the public safety incident (e.g., battery, aircraft fuel, work shift duration, etc.). If units need to be preempted, the learning processor 250 may deploy or reserve other resources. For example, in some examples the learning processor 250 may be configured to manage deployed units over time and adjust deployments as necessary based on inputs such as public safety officer shift patterns, vehicle fuel levels, and other data pertaining to the resource deployed by the learning processor 250 or electronic scheduling digital assistant 200.

In some examples the learning processor 250 may be configured, responsive to determining that no mobile imaging devices are currently available prior to the start of the interview window: identifying one or more already-scheduled mobile imaging devices assigned to one or more other interviews at least partially overlapping with the interview window; and reassigning at least one of the one or more already-scheduled mobile imaging device to the interview.

In some examples the learning processor 250 may be configured to manage resources prior to a scheduled interview, or may be configured to coordinate a time and date for a scheduling of live surveillance resources (personnel, drones, airborne units, etc.) to ensure such resources are at those locations of interest that have been identified from the investigation record. For example, in some examples the learning processor 250 may be configured as a scheduler 260 arranged to coordinate/schedule recorded data, e.g., access responsive to the at least one interview window time parameter the one or more electronically-stored existing case records associated with the interview and collate time-specific recorded video information and/or audio information from at least one resource deployed in advance of the interview and related to a recorded incident, etc.

In some examples, electronic processor 213 or processing unit 203 may perform all of the functions required of the electronic scheduling digital assistant 200, or in other examples the electronic processor 213 or processing unit 203 may encompass multiple signal processors, for example dedicated to the various technologies being supported. Alternatively, a single processor may be used to support each technology. Clearly, the various components within the electronic scheduling digital assistant 200 can be realized in discrete or integrated component form, with an ultimate structure therefore being an application-specific or design selection. Furthermore, it is envisaged that all or parts of the electronic scheduling digital assistant 200 or functions thereof may be stored on-premise software or in the cloud.

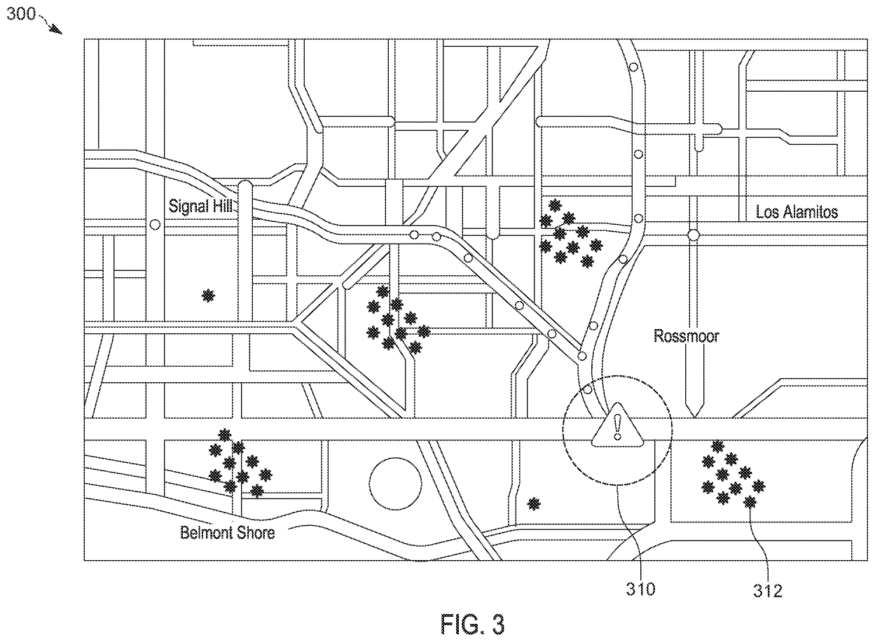

FIG. 3 illustrates an example of a map 300 provided to an electronic scheduling digital assistant, such as the electronic scheduling digital assistant 200 of FIG. 2, in accordance with some example embodiments. In some examples, it is envisaged that the electronic scheduling digital assistant may obtain an actual map of the location, which may be provided to the patrol officers 102, for example similar to the one provided by a geographic information system (GIS) location, as resources may be personnel moving to the scene. In some examples, it is envisaged that the map may contain relevant information, such as terrain conditions and any flight restrictions that may be present in the scene at the time of the interview that may restrict the access via flying drones. In some examples, if the resource is a drone, the map may include a set of coordinates, including elevation, and any restrictions that may be relevant (e.g., air spaces and elevations). In some examples, an existing map of the zone that the city and the Police department has may be used, for example based on GIS contracts to support the interview process. In some examples, the map information may be employed to establish various distance metrics used, for example, for determining an amount of time needed to deploy a mobile video device to point ‘A’ and again to point ‘B’, based on metrics of, say, air-distance, street distance, and pedestrian (short-cut) distance. In some examples, these metrics may be used to reflect a probability of obtaining ‘electronic eyes’ in place by the time they are needed for the interview. In some examples, these probabilities may be used, in turn and say when combined with a suitability of the type of video they can deliver, in prioritizing/negotiating (with competing City/government needs) for scheduling (or autonomous deployment) of mobile video devices as well as determining which mobile video devices should be deployed and how many are needed.

In accordance with some example embodiments, it is envisaged that the electronic scheduling digital assistant may be provided with pertinent location information relevant to the public safety incident. For example, in FIG. 3, the electronic scheduling digital assistant may be provided with pertinent location information related to locations of interest (identified as dashed circles) 310 and/or locations of drones or patrol officers with bodywear communications (BWC), etc., (identified as stars) 312. In accordance with some example embodiments, and for each location of interest, it is envisaged that the interviewer may be provided with one or more of the following: names of people or parties who were at the location of interest, a time and/or duration of colocation, a list of available resources that are available near the location(s) of interest that are deployable.

Referring now to FIG. 4, a data flow diagram 400 between components of the system for operating an electronic scheduling digital assistant of FIG. 1 and/or FIG. 2 is illustrated, in accordance with some embodiments. In accordance with some example embodiments, as soon as an interview room is scheduled to process a person of interest, the electronic scheduling digital assistant 200 (and in some example embodiments the learning processor 250 of the electronic scheduling digital assistant 200 of FIG. 2) immediately begins to coordinate resources that may be needed to facilitate real-time aspects of the interview. For example, when a crime or incident is reported, an investigation may be launched, and investigators may be assigned. In some examples, investigators may help create an investigation record 402, although in other examples, some of the information may be automatically populated. In some examples, it is envisaged that it will be up to the investigator to select persons of interest (POI), for whom clarification in their statements is needed. In accordance with some example embodiments, such resources may include: deployment of drones/aircraft to sites identified from evidence so far collected to be locations of interest 406, 414, which may include the drone's/aircraft's position, flying schedule, available fuel or flying time remaining; public safety officers for example wearing BWCs, who can be dispatched to check out what the interviewee is actually discussing, substantially in a real-time manner 416, which may include shift pattern data, available transportation, etc.; pre-recorded surveillance audio/video, etc.

In accordance with some example embodiments, the learning processor 250 may receive one or more additional or alternative pertinent factors, such as: locations of interest 408 (e.g., dates/times, details of any flight path restrictions, surveillance video and/or audio information related to a scene of a crime, or investigation records 402 such as recent interactions between interviewee and suspects or victims (for example based on statements to date, phone data and existing fixed camera data) or witness statements; a patrol schedule of officers near those locations of interest; travel-related information, such as distance, allocation, and fuel/battery charge constraints of deployable video sources); interview room details, such as the interview room schedule (for resource management purposes) 410. In some example embodiments the learning processor 250 of the electronic scheduling digital assistant 200 of FIG. 2 may be configured to use artificial intelligence to influence and/or direct the potential locations of interest to be considered by an inference engine or processor 404, for example based on the investigation records 402, and in response to a determined timeline associated with the incident. In some examples, the investigation records, such as witness statements, etc., may be directly passed 420 to the interrogation room schedule 410, such that a suitable interview time can be determined based on the interview room schedule 410 and any details (such as witness availability in the investigation records 402. In this manner, the person(s) of interest (POI) identified in the investigation record(s) 402, can be assessed and their selective appearance at an interrogation room be appropriately scheduled, as decided by the investigator(s) assigned to the case.

Turning now to FIG. 5, a flowchart diagram illustrates a process 500 for an electronic computing device operating as an electronic scheduling digital assistant to improve public safety related interviews. While a particular order of processing steps, message receptions, and/or message transmissions is indicated in FIG. 5 for exemplary purposes, timing and ordering of such steps, receptions, and transmissions may vary where appropriate without negating the purpose and advantages of the examples set forth in detail throughout the remainder of this disclosure.

At a scheduling computing device, the process 500 includes receiving interview scheduling information, at 510, wherein the interview scheduling information comprises at least one interview window time parameter associated with an interview window for interviewing an interviewee by an interviewer, the at least one interview window time parameter comprising at least one (but in some examples more than one) of the following: an interview start time, a scheduled end time of an interview, a date of an interview, a minimum duration of an interview. In some examples, the process includes receiving information about the incident. Given that the interview room schedule contains a name of the person of interest (POI), and in some instances a case number of the investigation, in some examples the learning processor 250 of the electronic scheduling digital assistant 200 of FIG. 2 may be configured to poll the location of interest extractor/predictor for the name of the POI scheduled for that room and the associated investigation number. In some examples, the learning processor 250 of the electronic scheduling digital assistant 200 of FIG. 2 may be configured may create yet a further database (as shown in Table 1) of what it is extracting and predicting, in this manner assisting investigators and avoiding having to reprocess the investigation records every time a query is needed.

TABLE 1
A partial example of data associated with a single POA and Investigation

| | | | | | |
|---|---|---|---|---|---|
| | Candidate Locations | Nearest | Air | Street | Pedest. |
| Statement | to explore with POI | Neighbor | Distance | Distance | Distance |

| | | |
|---|---|---|
| “I saw Quinn coming out of the 4^{th} street McDonalds” | Loc A | Loc B |
| “Quinn crossed the street, dropping a bag at the median | Loc B - Loc C | Loc E |
| “Reese asked to be picked up at the airport Hilton” | Loc D | Loc F |
| “Quinn got into a car parked at the Dennys.” | Loc E | Loc B |
| “Monday night, I saw something dragging behind the car | Loc F - Loc G | Loc D |
| as it went down the street in front of our office” | | |

At 520, the process includes accessing, responsive to the at least one interview window time parameter any electronically-stored existing case records associated with the interview.

At 530, the process includes processing information contained in the electronically-stored case records, and identifying one or more locations of interest likely to be relevant to the interview. In some examples, a single record from Table 1 will contain locations automatically extracted from the POI's earlier statements and contextual information about where they were (e.g., a city or neighborhood). A location is unsuitable for obtaining video footage (live or recorded) only if no government-accessible recorded video sources cover the area and no mobile video sources can be deployed to the area under sufficient lighting in advance of the interview.

At 540, the process includes determining that one or more mobile imaging device(s) is available prior to the start of the interview window. Here, it is noted that case records, such as: locations of interest 408 in FIG. 4 or witness statements may be overloaded with information in that there is a location of interest and associated constraints, but there is also information from government-accessible video/audio. In this instance, the learning processor 250 of the electronic scheduling digital assistant 200 of FIG. 2 may be configured to pull known schedule information from available records, such as related to aircraft in 406 or fixed video sources . . . whether government owned or private industry shared in 408 or deployable drone schedules in 414 or patrol officer schedules in 416 of FIG. 4. Next, in some examples, the learning processor 250 negotiates for the most likely to be available video sources, for example starting with the locations identified in Table 1. In one example, the learning processor 250 may schedule or deploy government-owned drones, prioritized by the greatest need, albeit that they may take longer to deploy (because of human pilots, typically helicopters) and may have limited visibility (due to altitude requirements), or deploy patrol officers at 416, which takes more time to deploy (because they are human) but can provide more flexibility in angles or video desired by the investigator. Availability and Quality of video are the two main factors for live video feeds.

At 550, the process includes causing the one or more available mobile imaging device(s) to be deployed to the one or more locations of interest prior to the start of the interview window. In this case, a crime scene may be a very complex one (e.g., a building with many stories). In such a situation, a deployment of several drones to properly inspect the location may be needed. It is also envisaged that in another scenario, there may be multiple witnesses and each may have a slightly different view of the scene, which will trigger multiple drones to inspect the zone in order to obtain the perspective of each one of them.

In some examples, it is envisaged that deployment instructions may be issued as a scheduled request in advance, for example to adjust a human pilot's flight plan in a case of 406 in FIG. 4. Acceptance would be required. If they need to adjust the flight path course during the interview, this may be performed either through a human dispatcher who relays the learning processor's 250 requests to the pilot. Alternatively, it is envisaged that the learning processor 250 may interact with a master drone controller (which might reject interrogation room requests to divert a drone to a life-saving mission, for example, or because of malfunctions or low power) in a case of 414 for FIG. 4. A yet further envisioned alternative, is that the learning processor 250 may instruct a resource via a message to the patrol officer who is already expecting instructions (but who must acknowledge being en route) in a case of 416 for FIG. 4.

Overall, it is envisaged that in some examples, the learning processor 250 may also try to additionally obtain pre-recorded video that most closely matches the time of day of the incident, based on witness accounts, deploying units to obtain such recordings (recordings rather than snapshots, if the statement speaks of a person walking, riding or driving from point ‘A’ to point ‘B’).

Referring now to FIG. 6, a more detailed flowchart 600 sets forth a number of further example process steps for operating the electronic scheduling digital assistant of FIG. 1 and/or FIG. 2 and/or FIG. 5, for improving public safety related interviews, in accordance with some embodiments. While a particular order of processing steps, message receptions, and/or message transmissions is indicated in FIG. 6 for exemplary purposes, timing and ordering of such steps, receptions, and transmissions may vary where appropriate without negating the purpose and advantages of the examples set forth in detail throughout the remainder of this disclosure.

At a scheduling computing device, the flowchart 600 includes receiving interview scheduling information at 610, wherein the interview scheduling information comprises at least one interview window time parameter associated with an interview window for interviewing an interviewee by an interviewer, the at least one interview window time parameter comprising at least one of the following: an interview start time, a scheduled end time of an interview, a date of an interview, a minimum duration of an interview. At 620, the process includes accessing responsive to the at least one interview window time parameter any electronically-stored existing case record(s) associated with the interview. At 630, the process includes processing information contained in the electronically-stored case record(s), and identifying one or more locations of interest likely to be relevant to the interview. At 640, the process includes determining that one or more mobile imaging device(s) is available prior to the start of the interview window.

At 650, the process includes determining whether a number of available mobile imaging devices is less than a number of locations of interest. In some examples, the number of relevant locations may be identified by the investigator/officer in command (for example if there are multiple witnesses describing the same location, the investigator/officer may choose to obtain multiple perspectives). Furthermore, when determining the availability of the devices, it is envisaged that, for example, each one of the drones may have a status field, in which it is possible to determine the activity it is in (e.g., at scene, commuting, recharging, ready, failure state, etc.). Additionally, for the officers for example, it is envisaged that the scheduler system is connected to the Police Department Computer Assisted Dispatch system, in which it is possible to know the status of each officer, to know their availability. If the number of available mobile imaging devices is not less than a number of locations of interest at 650, the process moves to 660, where the scheduling computing device causes the one or more available mobile imaging device to be deployed to the one or more locations of interest prior to the start of the interview window. If the number of available mobile imaging devices is less than a number of locations of interest at 650, the process moves to one of two legs, although it is envisaged that a skilled artisan could readily appreciate other scenarios where alternative legs may be used or are possible. At a first leg, at 652, the process includes proposing, via an electronic message to the interviewer and prior to the interview window, a subset of locations of interest for deployment of the one or more available mobile imaging devices. Thereafter, at 654, the process includes requesting an electronic confirmation prior to deployment. In some examples, it is envisaged that a prioritization algorithm may take, say, two main factors into consideration: (1) usability and (2) probability of a source being available when needed. Without confirmation, the second factor may decrease as time passes, e.g., by the minute. In this manner, other video sources become prioritized. In some examples, it is also envisaged that it may always be possible that no video source will be available when the interviewer wants to take a POI through the scene (e.g., a drone could crash, be low on power, patrol officer's shift could end, get stuck in traffic, etc.); an in this regard an objective is to make this scenario unlikely. At a second leg, at 656, the process includes proposing, via an electronic message to the interviewer and prior to the interview window, a subset of locations of interest for deployment of the one or more available mobile imaging devices. Thereafter, at 658, the process includes selecting, by the electronic computing device, a subset of locations of interest for deployment of the one or more available mobile imaging devices as a function of the prioritization mapping. In some examples, prioritization mapping may take two main factors into consideration: (1) usability and (2) probability of the source being available, when needed.

In some alternative or additional examples, it is envisioned that the flow 652-654-660 and 656-658-660 may be supplemented or replaced with an identification of a primary and backup (and possibly tertiary, if humans are needed for the first two) plans for selecting mobile video devices for each location of interest (in advance, as deemed relevant) by the interrogating investigator. Any humans affected by standby plans may be informed that they are on standby. In this instance, as the interview time approaches, that status can be elevated to primary (or removed upon confirmation of the primary plan's execution). Drones do not require any such advanced warning however, but they still need to be coordinated. In this example, a selection of primary and backup scheduling plans may be optimized based on usability (#1) and probability of the source being available (#2), with #2 being improved through reuse of a mobile device in hitting multiple locations, as only one location of interest can be shared with an interviewee at a time. Also, in order to increase #2, it is considered that it may actually be useful to overbook resources in some examples, which (unlike technician routing) can be acceptable, especially if two resources can provide meaningfully different video vantage points of the same location.

It is also noted that if the time of day of the interview is nowhere near the time of day of the incident in question, it may be useful to obtain pre-recorded video as well, through, say, prioritized deployment of video devices. In such a case, #2 is much higher because the window of need is much wider (possibly several hours wide, depending on weather).

For completeness, it is noted that fixed cameras are less usable; pan-controlled cameras are slightly more usable; and patrol officers may be able to provide video from inside a building and therefore wherever a POI may have actually traveled; whereas drones and aircraft are limited to outdoors. It is also noted that drones can hover over roofs and behind fences, and offer advantages in this regard. For completeness, it is also noted that for live video, for example to jump from one location to another, either a different video source may be used, or a mobile source may be directed to travel the distance. However, the greater the distance, the lower the probability of being available in the time needed. Using the locations record example from Table 1, as one example, a resource optimizer may determine that a single drone may cover Location ‘A’, then cover the path from ‘B’ to ‘C’, and then cover Location ‘E’, all based on distance metrics and the scheduled location for that drone prior to and after it will be needed. Meanwhile, the resource optimizer may determine that a patrol officer may cover Location ‘F’ through ‘G’, followed by location ‘D’, based on the street distance between where they will be stationed prior to when the video is needed, and Location ‘F’, and the street distance between ‘G’ and ‘D’.

It is assumed that the Interrogating Investigator will have a dashboard showing which locations are available now and which have recordings so that they can be punched up. In the case of a patrol officer, the interrogating investigator could provide directions in real-time. Confirmation (as indicated by mission acceptance or enroute acknowledgement) and ultimately location tracking of the mobile video device contribute to assessment of the probability, which would cause the scheduler to de-prioritize setting up alternate sources of video. Following 654 or 658, at 660, the process includes causing, by the scheduling computing device, the one or more available mobile imaging device to be deployed to the one or more locations of interest prior to the start of the interview window.

At 670, the process includes providing, to the interviewer prior to or at the beginning of the interview window, the determined locations of interest to which the one or more mobile imaging devices have been deployed. At 675, the process includes providing real-time visualization data received from the deployed one or more mobile imaging device(s) to the interviewer prior to the start of the real-time public safety related interview. At 680, the process includes providing the interviewer with an ability to influence the location of the deployed one or more available mobile imaging device(s), and thereby provide adapted real-time visualization data to the interviewer in response to information obtained in the public safety related interview. One example of providing the interviewer with an ability to influence the location of the deployed one or more available mobile imaging device, could be that the POI mentions “hey, I remember seeing him throw something on the roof over there.” The interviewer would then want to direct a drone to adjust, say, the angle and altitude to capture the roof that was mentioned. Similar changes could involve directing a patrol officer (via 116, for example) to walk with a Body-Worn Camera (BWC) 112 behind a fence. At 690, the process includes responsive to a request from the interviewer, causing one or more of the deployed one or more available mobile imaging devices to begin providing one or more of live images or video of a location of interest.

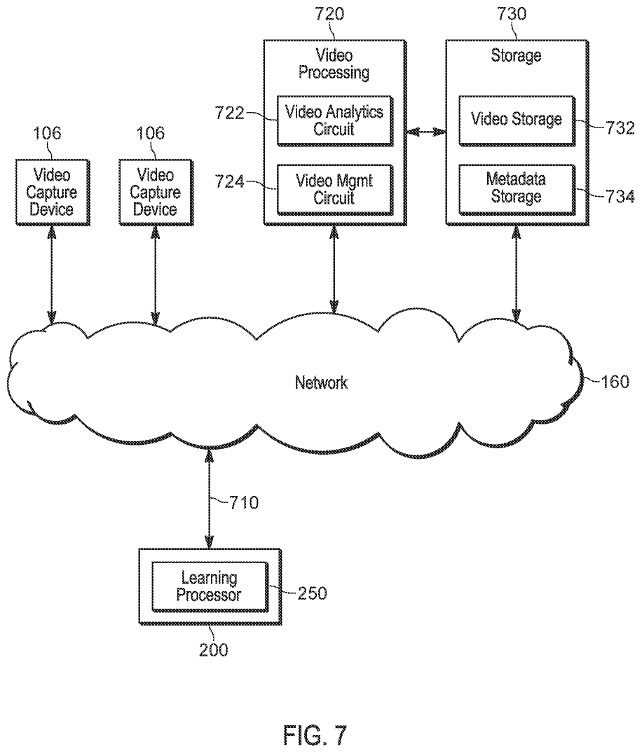

Referring now to FIG. 7, a block diagram of a set of operational circuits of the system 100 of FIG. 1 is illustrated, according to one example embodiment. The operational circuits may be implemented in hardware, software or both. In accordance with one example embodiment, the operational circuits may provide real-time information to the The set of operational circuits of FIG. 7 include at least one video capture device 106, for example carried by a law-enforcement officer as a BWC or included in a law enforcement vehicle or in a drone or airborne unit. For example, each video capture device 106 may implement a video capture device 106 to capture images, such as a drone, or a public safety officer with a body wear camera. The set of operational circuits may also include one or more image/video data processing devices 720, for example, including a video analytics circuit 722 and a video management circuit 724. The video management circuit 724 receives image data and performs processing functions on the image data related to video transmission, playback and/or storage. For example, the video management circuit 724 can process the image data to permit transmission of the image data according to bandwidth requirements and/or capacity to the electronic scheduling digital assistant 200 across a wireless network 160 and a connection 710 to the learning processor 250 in the electronic scheduling digital assistant 200. The video management circuit 724 may also process the image data according to playback capabilities of a learning processor 250 in the electronic scheduling digital assistant 200 that will be playing back the video, such as processing power and/or resolution of the display of the learning processor 250. The video management circuit 724 may also process the image data according to storage capacity within a video management system for storing image data.

The set of operational circuits may further include one or more storage devices 730, configured to hold previously recorded video or image data. For example, and as illustrated, the storage device 730 includes a video storage 732 and a metadata storage 734. The video storage 732 stores image/video data, which may be image/video data processed by the video management circuit. The metadata storage 734 stores information data output from the video analytics circuit 722.

In some example embodiments, the video analytics circuit 722 receives image data and analyzes the image data to determine properties or characteristics of the captured image or video and/or of objects found in the public safety incident scene represented by the image or video. Based on the determinations made, the video analytics circuit 722 may further output metadata providing information about the determinations. Examples of determinations made by the video analytics circuit 722 may include one or more of foreground/background segmentation, object detection (such as a weapon discarded at the scene), object tracking (such as an assailant or suspect), object classification, virtual tripwire, anomaly detection, facial detection, facial recognition, license plate recognition, identifying objects “left behind” or “removed”, unusual motion, and business intelligence. However, it will be understood that other video analytics functions known in the art may also be implemented by the video analytics circuit 722.

In accordance with some examples, the learning processor 250 of the electronic scheduling digital assistant 200 is configured to obtain/receive real-time (or stored) video footage from one or more of the video capture devices 106, video processing devices 720 or storage 730. The learning processor 250 may comprise a prediction circuit, typically in a form of a machine learning (ML)-based processor/circuit, that may be configured to predict one or more factors relating to a public safety incident based on the obtained video footage in order to improve real-time public safety related interviews. In some examples, the prediction may be based on the determined properties or characteristics of the captured image or video and/or of objects found in the public safety incident scene represented by the image or video.

It will be understood that while video storage 732 and metadata storage 734 are illustrated as separate circuits, they may be implemented within a same hardware storage whereby logical rules are implemented to separate stored video from stored metadata. In other example embodiments, the video storage 732 and/or the metadata storage 734 may be implemented using hardware storage using a distributed storage scheme. The learning processor 250 may comprise a video playback circuit configured to receive image data and playback the image data as a video.

In a further alternative example, the learning processor 250 may use facial recognition (as is known in the art) to detect faces in the images of humans and accordingly provides confidence levels. The appearance search system of such an example may include using feature vectors of the images or cropped bounding boxes of the faces instead of the whole human. Such facial feature vectors may be used alone or in conjunction with feature vectors of the whole object. Further, feature vectors of parts of objects may similarly be used alone or in conjunction with feature vectors of the whole object.

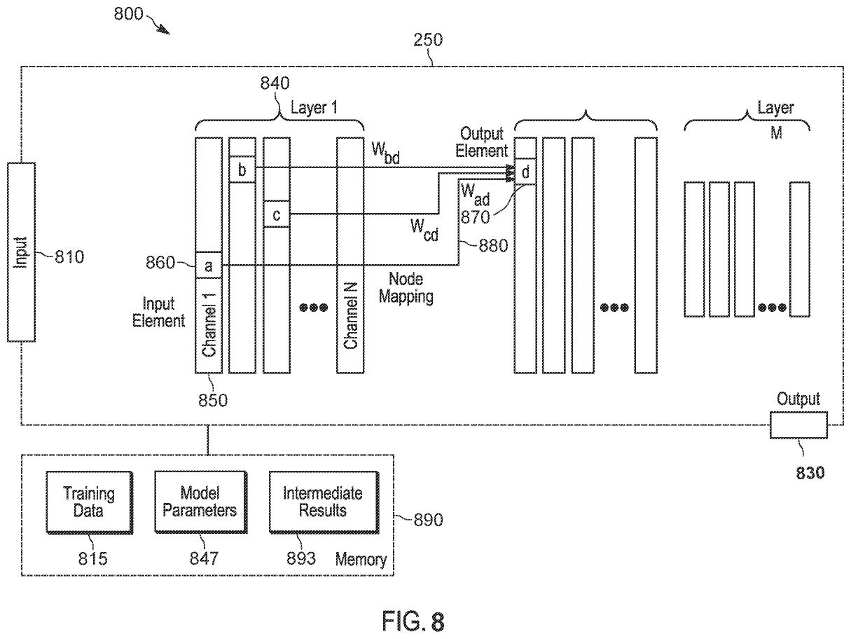

Referring now to FIG. 8, an example of a neural network 800 that may be employed as a learning processor, such as an artificial intelligence (AI)-based learning processor such as learning processor 250 in FIG. 2, is described to improve real-time public safety related interviews according to some examples. In some examples, the example neural network 800 may comprise a convolutional neural network 800 that is arranged to apply a series of node mappings 880 to an input 810, which ultimately resolves into an output 830 consisting of one or more values, from which at least one of the values is used by the neural network 800. The example (convolutional) neural network 800 comprises a consecutive sequence of network layers (e.g., layers 840), each of which consists of a series of channels 850. The channels are further divided into input elements 860. In this example, each input element 860 may store a single value. Some (or all) input elements 860 in an earlier layer are connected to the elements in a later layer by node mappings 880, each with an associated weight. The collection of weights in the node mappings 880, together, form the neural network model parameters 847. For each node mapping 880, the elements in the earlier layer are referred to as input elements 860 and the elements in the output layer are referred to as the output elements 870. An element may be an input element to more than one node mapping, but an element is only ever the output of one node mapping 880.

In order to calculate the output 830 of the (convolutional) neural network 800, the system first considers the input layer as the earlier layer. The layer(s) to which the earlier layer is connected by a node mapping 880 is/are considered, in turn, as the later layer. The value for each element in later layers is calculated using the node mapping 880 in equation [1], where the values in the input elements 860 are multiplied by their associated weight in the node mapping 880 and summed together.

$$Node mapping 880 : d = A ( {w}_{ad} \times a + {w}_{bd} \times b + {w}_{cd} \times c ) \qquad [ 1 ]$$

The result of the summing operation is transformed by an activation function, ‘A’ and stored in the output element 870. The (convolutional) neural network 800 now treats the previously considered later layer(s) as the earlier layer, and the layers to which they are connected as the later layers. In this manner, the (convolutional) neural network 800 proceeds from the input layer 840 until the value(s) in the output 830 have been computed.

In some examples, the (convolutional) neural network 800 may be trained. In some examples, the training of the convolutional neural network 800 may entail repeatedly presenting data as the input 810 of the (convolutional) neural network 800, in order to improve real-time public safety related interviews. In some examples, an optimization algorithm may be used to reduce a loss function, for example by measuring how much each node mapping 880 weight contributed to the loss, and using this to modify the node mapping 880 in such a way as to reduce the loss. Each such modification is referred to as an iteration. After a sufficient number of iterations, the convolutional neural network 800 can be used to analyze the input video data to assist a real-time public safety related interview.

In some examples, the large number of model parameters 847 used in the (convolutional) neural network 800 may require the device to include a memory 890. The memory 890 may be used to store the training data 815, the model parameters 847, and any intermediate results 893 of the node mappings.

Thus, in the learning processor 250, input data (e.g., a training dataset, clinical dataset, model parameters or intermediate results) is fed to the learning processor 250 neural network in a format that fits the input matrix. Nodes are mapped in a specific way that is adapted to the purpose of the device (forming e.g., a convolutional neuronal network). The information is gradually reduced through a series of interconnected input/output elements to generate the final output.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (for example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for scheduling, the method comprising at a scheduling computing device:
receiving interview scheduling information, wherein the interview scheduling information comprises at least one interview window time parameter associated with an interview window for interviewing an interviewee by an interviewer, the at least one interview window time parameter comprising at least one of the following: a start time of an interview, a scheduled end time of the interview, a date of the interview, a minimum duration of the interview;
accessing, responsive to the at least one interview window time parameter, one or more electronically-stored existing case records associated with a public safety related interview;
processing information contained in the one or more electronically-stored existing case records, and identifying one or more locations of interest relevant to the interview;
determining that one or more mobile imaging devices is available prior to a start of the interview window; and
causing the one or more available mobile imaging devices to be deployed to the one or more locations of interest prior to the start of the interview window.

2. The method of claim 1 further comprising, at the scheduling computing device, providing real-time visualization data received from the deployed one or more available mobile imaging devices to the interviewer prior to the start of the public safety related interview.

3. The method of claim 1 further comprising, at the scheduling computing device and after a start of the interview window, providing the interviewer with an ability to influence the location of the deployed one or more mobile imaging devices at the one or more locations of interest to provide adapted real-time visualization data to the interviewer in response to information obtained in the public safety related interview.

4. The method of claim 3, the method further comprising, responsive to a request from the interviewer, causing the deployed one or more mobile imaging devices to begin providing one or more of live images or a video of the location of interest to at least one of the interviewer and the interviewee.

5. The method of claim 1 further comprising, at the scheduling computing device:
receiving resource information related to the deployed one or more mobile imaging devices; and
adjusting the deployments of the one or more mobile imaging devices in response to the received resource information, wherein the received resource information comprises one or more of: a shift pattern of a public safety officer deployed as the one or more mobile imaging devices, remaining fuel of the one of more mobile imaging devices.

6. The method of claim 1, at the scheduling computing device and prior to the interview window, wherein accessing responsive to the at least one interview window time parameter the one or more electronically-stored existing case records associated with the interview comprises collating at least one of: time-specific video information from at least one resource related to a recorded incident; and audio information from at least one resource related to a recorded incident.

7. The method of claim 1, wherein determining that the one or more mobile imaging devices is available prior to the start of the interview window comprises:
determining that a number of available mobile imaging devices prior to the start of the interview window is less than a number of locations of interest associated with the interview;
proposing, via an electronic message to the interviewer and prior to the interview window, a subset of locations of interest for deployment of the one or more mobile imaging devices; and
requesting an electronic confirmation of the subset of locations prior to deployment of the available one or more mobile imaging devices.

8. The method of claim 1, wherein determining that one or more mobile imaging devices is available prior to the start of the interview window comprises:
determining that a number of the one or more mobile imaging devices prior to the start of the interview window is less than a number of locations of interest associated with the interview;
accessing a prioritization mapping of an incident associated with the interview; and
selecting a subset of locations of interest for deployment of the one or more mobile imaging devices as a function of the prioritization mapping.

9. The method of claim 1, the method further comprising providing, to the interviewer prior to or at a beginning of the interview window, determined locations of interest to which the one or more mobile imaging devices have been deployed with at least a portion of the one or more electronically-stored existing case records from which the locations of interest were identified.

10. The method of claim 1, the method further comprising, responsive to determining that no mobile imaging devices are currently available prior to the start of the interview window:
identifying one or more already-scheduled mobile imaging devices assigned to one or more other interviews at least partially overlapping with the interview window; and
reassigning at least one of the one or more already-scheduled mobile imaging device to the interview.

11. The method of claim 1, wherein causing the one or more mobile imaging devices to be deployed to the one or more locations of interest prior to the start of the interview window comprises causing multiple available mobile imaging devices of differing types to the one or more locations of interest.

12. The method of claim 1, wherein causing the one or more mobile imaging devices to be deployed to the one or more locations of interest comprises scheduling at least one of: a live surveillance resource of a public safety officer; live surveillance resource of a public safety officer having a body warn camera, a public safety vehicular camera, a live surveillance drone resource, and a live surveillance airborne unit.

13. A scheduling computing device comprising:
a receiver arranged to receive public safety related interview scheduling information that comprises at least one interview window time parameter associated with an interview window for interviewing an interviewee by an interviewer, the at least one interview window time parameter comprising at least one of: an interview start time, a scheduled end time of an interview, a date of an interview, a minimum duration of an interview;
one or more electronic processors operably coupled to the receiver and arranged to:
access, responsive to the at least one interview window time parameter, one or more electronically-stored existing case records associated with a public safety related interview;
process information contained in the one or more existing electronically-stored case records, and identifying one or more locations of interest relevant to the interview;
determine that the one or more mobile imaging devices is available prior to a start of the interview window; and
an output port, coupled to the one or more electronic processors and arranged to output instructions to cause the one or more available mobile imaging devices to be deployed to the one or more locations of interest prior to the start of the interview window.

14. The scheduling computing device of claim 13 further comprising a user interface operably coupled to the one or more electronic processors and arranged to provide real-time visualization data received from the deployed one or more mobile imaging devices to the interviewer prior to the start of the public safety related interview.

15. The scheduling computing device of claim 14 wherein, after a start of the interview window, the one or more electronic processors is configured to provide via the user interface the interviewer with an ability to influence the location of the deployed one or more mobile imaging devices at the one or more locations of interest to provide adapted real-time visualization data to the interviewer in response to information obtained in the public safety related interview.

16. The scheduling computing device of claim 15, wherein the one or more electronic processors is arranged, responsive to a request from the interviewer, to cause the deployed one or more mobile imaging devices to begin providing to at least one of the interviewer and the interviewee one or more of: live images or video of a location of interest.

17. The scheduling computing device of claim 13 wherein the receiver is arranged to receive resource information related to the deployed one or more mobile imaging devices; and the one or more electronic processors is configured to adjust the deployment of the one or more mobile imaging devices in response to the received resource information, wherein the received resource information comprises one or more of the following: a shift pattern of a public safety officer deployed as the one or more mobile imaging devices, remaining fuel of the one of more mobile imaging devices.

18. The scheduling computing device of claim 13 wherein, prior to the interview window, the one or more electronic processors is configured to access responsive to the at least one interview window time parameter the one or more electronically-stored existing case records associated with the interview and collate time-specific video information or audio information from at least one resource related to a recorded incident.

19. The scheduling computing device of claim 13, wherein the one or more electronic processors being configured to determine that the one or more mobile imaging devices is available prior to the start of the interview window comprises the one or more electronic processors being configured to determine that a number of available one or more mobile imaging devices prior to the start of the interview window is less than a number of locations of interest associated with the interview, and one of:
propose, via an electronic message to the interviewer and prior to the interview window, a subset of locations of interest for deployment of the one or more mobile imaging devices; and
request an electronic confirmation prior to deployment;
or
access a prioritization mapping of an incident associated with the interview, and
select a subset of locations of interest for deployment of the one or more mobile imaging devices as a function of the prioritization mapping.

20. The scheduling computing device of claim 13, wherein the one or more electronic processors is configured to provide, to the interviewer prior to or at a beginning of the interview window, determined locations of interest to which the one or more mobile imaging devices have been deployed with at least a portion of the one or more electronically-stored existing case record from which the locations of interest were identified.
